(19) United States
(12) Patent Application Publication
(10) Pub. No.: US 2008/0247532 A1
(43) Pub. Date: Oct. 9, 2008

(54) Method and System for Representing Quantitative Properties in a Computer Program and for Validating Dimensional Integrity of Mathematical Expressions

(76) Inventor: Waldean Allen Schulz, Boulder, CO (US)

Correspondence Address: HANSEN HUANG TECHNOLOGY LAW GROUP, LLP, 1725 EYE STREET, NW, SUITE 300, WASHINGTON, DC, 20006, US

(21) Appl. No.: 11/697,500

(22) Filed: Apr. 6, 2007

(51) Int. Cl. H04M 7/00

(52) U.S. Cl. 379/220.01

(57) ABSTRACT

A software method and system for efficiently representing values of quantitative properties, or dimensions, such as scientifically measured or computed quantities. Each quantitative dimension may be represented by a class defined in an object-oriented programming language. Each quantity of a dimension is represented by an object of the class representing the dimension objects may be used without knowledge of the internal representation of its objects. The class provides storage and computational efficiency comparable to that of using a computer's native numbers of the same range and precision as the quantities involved. The classes may include object constructors, arithmetic operators, and constants representing conventional units of measurement. Type-safe operators and functions in a mathematical expression accept quantity objects as arguments and compute objects as results. The method and system provide for compile-time validation of the dimensional integrity of the expression.

### FIELD OF THE INVENTION

The present invention relates to methods and systems for efficiently representing and efficiently computing values of quantitative properties in computer software and for validating the dimensional integrity of formulas and mathematical expressions involving those values.

### BACKGROUND OF THE INVENTION

Presently, most computer programming languages, such as C, C++, Java, Pascal, Ada, BASIC, and FORTRAN, support computation with floating-point numbers, which are limited, finite approximations to real numbers. Further, binary floating point numeric computation is commonly supported by hardware arithmetic circuitry native to the computers for which programs are written in such languages. Instead of native hardware floating point, more primitive computers may implement some form of numerical representation and arithmetic in software. Also, numerical software libraries are commonly available and provide approximations to mathematical functions, such as logarithms and trigonometric functions. These functions in addition to the common arithmetic operators involve numeric arguments and results represented by such software or hardware numbers.

For the purposes herein, and with no loss of generality, the description will assume that the native numbers are represented as a common floating-point numeric format, such as the IEEE-754 Standard single-precision or double-precision binary numbers. Alternative representations of approximations to real numbers can be used as well, such as a decimal floating point format, fixed point binary, fixed point decimal, fractions with integral numerators and denominators, or a custom nonstandard numeric format. The description herein will assume that the standard arithmetic operators (typically denoted by symbols +, −, *, /) and relational operators (typically including at least the symbols <, =, >) are available for the numeric format to use for computation.

In many application programs these numbers are frequently used to represent the values of measurable quantities of various physical, chemical, and engineering properties. These properties, for example, can include distance (or length), area, volume, angle, elapsed time (period or duration), velocity, acceleration, pressure, energy, power, concentration, temperature, viscosity, voltage, and so forth. Typically, quantities of these properties are represented in a computer by variables and constants of the ordinary native numbers provided in the programming language used. The native numbers in turn are generally implemented directly on the computer hardware.

When the value of a quantity of some physical property is typically represented by a number in a programming language's native number system, the unit of measurement is very relevant but is implicit. For example, a number may represent a distance (or length) quantity using a presumed unit of measure such as inches or centimeters. A frequent problem is that sometimes the wrong unit of measure is inadvertently assumed while composing computational formulas or when processing input values, and such an incorrect assumption leads to an incorrect computed result. For example, imperial (UK) gallons may be mistaken for US gallons. A well known instance involving incorrect units of measure was the failure of NASA's 125 million dollar Mars Climate Orbiter in September 1999. In that project, metric units (newton-seconds) were assumed in the satellite software, but English units (pound-seconds) were assumed in the ground station software.

Even when units and numerical values representing measurements are used correctly, a user often needs to explicitly convert a value relative to one unit into the corresponding value relative to another unit. For example, unit conversion may need to be performed when adding two lengths, such as where one length is a value expressed in centimeters and the other length is a value expressed in inches. Then a user must choose a common unit for the addition, apply appropriate conversion constants, and keep track of the unit associated with the resultant sum. Preferably, such conversions should be correctly handled automatically for the user, and appropriate conversion constants automatically supplied by an underlying method or system.

Further, a quantity of one property may be mistakenly used in a situation expecting a quantity of an entirely different property. For example, a velocity quantity may be inadvertently used where an acceleration quantity is expected. Even more subtly, pounds of force may be mistaken for pounds of mass. Similarly, newton•meters of torque may be confused with newton•meters of energy. In software in which all such quantities are naively represented by the ordinary, native numbers of the programming language (and the underlying computer hardware), a compiler will not and cannot detect this kind of error.

Quantitative properties need not be physical. One important example is monetary quantities of a property ‘worth’ or ‘financial value’, which are generally expressed as numbers relative to a unit of currency. Common units of the monetary property include US dollars, Euros, Yen, or other national currencies. Because the relative numerical values of such currencies are variable within the global marketplace, a constant unit of measure has sometimes been employed, such as an ounce of gold, silver, or platinum, but even that may vary with changes of availability. Alternatively, one particular currency, such as the US dollar, may be taken as the constant unit of measurement having a value of 1.00.

### SUMMARY OF THE INVENTION

Therefore, it is desirable to have a method or system which treats quantities of differing properties in a type-safe way so that their usage can be distinguished and validated by a conventional programming language compiler, translator, interpreter, or a source code preprocessor even before a program is executed. It may also be desirable that the method or system contribute to the “self-documentation” of the software source code by using meaningful naming conventions.

For the purposes herein, a ‘quantity’ will be assumed to comprise a numerical ‘value’ and to be an instance of a specific measurable or quantitative ‘property’ or ‘dimension’. Each particular property may have one or more standard or customary units of measurement. Each unit of measurement is a quantity of the property and generally has a constant value. Conventionally, one such unit is given the value 1 and the other units are defined relative to it. Several traditional, national, international, and standardized systems exist for defining the units of some set of properties (or dimensions). Examples include the metric MKS system, the metric CGS system, and the SI international system of metric units. National standards include US and British systems of units, which now define their units in terms of the SI system.

Note that quantitative properties are often called ‘dimensions’, and the term ‘dimensional analysis’ means validating the correct and compatible usage of quantities of various properties within an arithmetic formula or mathematical expression. This specification will refer to applying dimensional analysis to a mathematical expression composed of arithmetic operator symbols (+ − × /), relational symbols (< = >), and function calls as ‘validating the dimensional integrity’ of the expression. In this specification the terms ‘property’ and ‘dimension’ are synonymous. Nevertheless, ‘property’ may be preferred over the term ‘dimension’, because the term ‘dimension’ is often more narrowly construed to mean the specific spatial property called distance or length. For example, the size of a rigid three-dimensional physical body may be specified by three distances: length, width, and height. In the same vein, non-technical people may not think of the physical properties acceleration, energy, and voltage as ‘dimensions’. Further, within programming languages, the term ‘dimension’ is a yet another concept, which is associated with arrays of values. Nevertheless, in physics, ‘dimension’ is the conventionally used term.

### BRIEF DESCRIPTION OF THE DRAWINGS

The accompanying drawings, which are incorporated herein and constitute part of this specification, illustrate presently preferred embodiments, and, together with the general description given above and the detailed description given below, serve to explain features of the embodiments.

FIG. 1 is a table of some common quantitative properties (dimensions) and some of the standard or conventional units associated with each property (dimension).

FIG. 2 is a flow diagram of a typical computer programming setup.

FIG. 3 lists the standard metric prefixes and their values as defined in an embodiment expressed in the C++ programming language.

FIGS. 4A, 4B, and 4C are listings of source code for an embodiment expressed in the C++ programming language for base class definitions on which each class representing a specific scalar-valued quantity may be built.

FIGS. 5A and 5B are listings of source code for an embodiment of a definition for a class named ‘velocity’ as expressed in the C++ programming language.

FIGS. 6A and 6B shows correct and incorrect examples of computations involving quantities from several classes.

FIGS. 7A and 7B are source code listings for a parameterized macros for defining a real-valued, linear-scale class for a new quantitative property (dimension).

FIGS. 8A and 8B are source code listings for an embodiment of an alternate definition for a class named ‘velocity’ which uses the macros of FIGS. 7A and 7B.

FIGS. 9A and 9B show examples of AC electrical computations involving complex-valued quantities.

FIGS. 10A and 10B are source code listings for an embodiment of a base class for complex-valued quantities.

FIGS. 11A and 11B list a set of macros for defining a complex-valued class for a new quantitative property.

FIGS. 12A and 12B are source code listings for an embodiment for a class representing quantities of sinusoidal AC (alternating current) voltage.

FIGS. 13A and 13B are source code listings for an embodiment for a base class definition from which to derive a specific logarithmic-scale class.

FIGS. 14A and 14B are source code listings for a set of macros for defining a real-valued logarithmic-scale class for a new quantitative property.

FIGS. 15A and 15B lists an embodiment for a logarithmic-scale class representing sound intensity.

### DETAILED DESCRIPTION

Various embodiments of the present invention will be described in detail with reference to the accompanying drawings.

Some previous attempts to deal with the problems stated above fall into two main categories. One category proposes to extend a programming language compiler or interpreter to recognize units of measure. The obvious disadvantage of this is the large cost of such a project and the effort of upgrading the large installed base having the existing language. Another category “tags” each quantity with an explicit run-time representation of the unit—generally requiring both extra memory space and execution time overhead. One such popular method is to choose a fixed set of fundamental units of measure, each unit corresponding to a fundamental property (dimension). An example set of fundamental units consists of the following: meter (for distance or length property), gram (mass), second (time), coulomb (charge), candela (luminosity), kelvin (temperature), and radian (angle). That is, each property may be represented by a set of explicit integer exponents, one for each fundamental unit. For example,

acceleration=meter¹•gram⁰•second⁻²•coulomb⁰•candela⁰•kelvin⁰•radian⁰.

The obvious disadvantages of this are that there is a fixed set of fundamental properties and a fixed set of corresponding units. Note that a majority of the combinations of the integer exponent values represent meaningless units. Further, it is not possible to represent units of certain important quantitative properties using the above set of fundamental units. Examples of such important properties and units include an amount of ‘information’ as measured in ‘bits’, ‘information density’ measured in ‘bits/cm^{2,}’ ‘worth’ measured in ‘US dollars’ or ‘Euros’, and ‘sound loudness’ measure in ‘decibels’. In order to do so, a new fundamental unit may be required for each such quantitative property, and therefore yet another integer exponent must be added for the property of each new unit. Adding one or more new fundamental units to the exponent-based system may involve augmenting the underlying run-time data structure in a way which may not be backward compatible with the previous scheme. Furthermore, the exponent system requires run-time memory storage overhead for the set of integer tags and requires run-time execution overhead to compute new integral tag values for the result in addition to the time required to compute the resultant numerical value of a mathematical expression (formula). Additional run-time may be required to validate the dimensional integrity of the operators and the operands on which they operate. In any case, such a system of exponents generally does not allow for compile-time validation of the dimensional integrity of mathematical expressions by a conventional compiler. This is because, in the general case, the values of the exponents of a quantity may not be accessible to a compiler and may not be known until run-time. Stating it differently, all quantities are typically represented as objects of a single class, which represents all quantitative properties (dimensions). Therefore, arithmetic and relational (comparison) operators acting on such objects as operands cannot be validated to be correct and meaningful at compile-time with respect to the properties of the specific individual operands of the operators. To use programming language terminology, the operators and objects are not ‘type-safe’ with respect to the many properties represented by the various integer exponent values. In effect, the ‘type’ of the result of a mathematical expression must be computed and checked at run time.

In contrast to the explicit exponents associated with a fixed set of properties, a different method, presented herein, can exploit the built-in strong (type-safe) compile-time data type validation provided by an object-oriented programming language without modifying a programming language's conventional compiler or interpreter. An embodiment of the method may include source code which defines a class (also known as an abstract data type) to uniquely represent each distinct quantitative property to be referenced by a program. Each object of the class represents a quantity of the quantitative property (dimension) represented by the class. Therefore, a quantitative property and the unique software class (abstract data type) which represents the property may be considered essentially synonymous for the purposes of this specification. Similarly, a quantity of the property and a computer memory object of the class representing the property may be considered synonymous.

By conventional compiler, this specification means a compiler which compiles a standardized programming language, such as C++, Java, C#, or another modern object-oriented language. The compiler runs on a computer which includes an instruction processor and a memory having stored therein source code statements of the programming language, which are accessible to the instruction processor. For example, the memory may be semiconductor memory, magnetic memory, optical memory, or a combination thereof. The memory for the computer also includes a compiler for the programming language. The compiler includes instructions for the instruction processor which cause the instruction processor of the computer to access and compile the source code statements stored in the memory of the computer. Further, this specification assumes the programming language has no built-in features specifically intended for representing units and/or the quantitative properties represented by those units. This specification will include under the generic term ‘compile’ the normal translation and linking of source code into machine code, the translation to interpreted intermediate code (such as with Java), and direct interpretation of the source code.

Because each quantitative property uniquely corresponds to a specific property class representing the property, the concepts of a property and the software class representing the property may be used interchangeably without introducing confusion. Doing so sometimes keeps the description simpler. The terms property class and dimension class then means a class representing the property (dimension). Similarly, the concept of a property quantity and a software object of the class representing the quantity's property may be used interchangeably. For example, one may speak of a quantity belonging to a property class, whereas technically the quantity is really associated with a property, and the object corresponding to the quantity is actually what belongs to the property class, which represents the quantity's property. Thus a quantity and the object representing it may also be treated as synonymous in general. The term quantity object then means an object representing the quantity, and the object belongs to the class representing the property of the quantity.

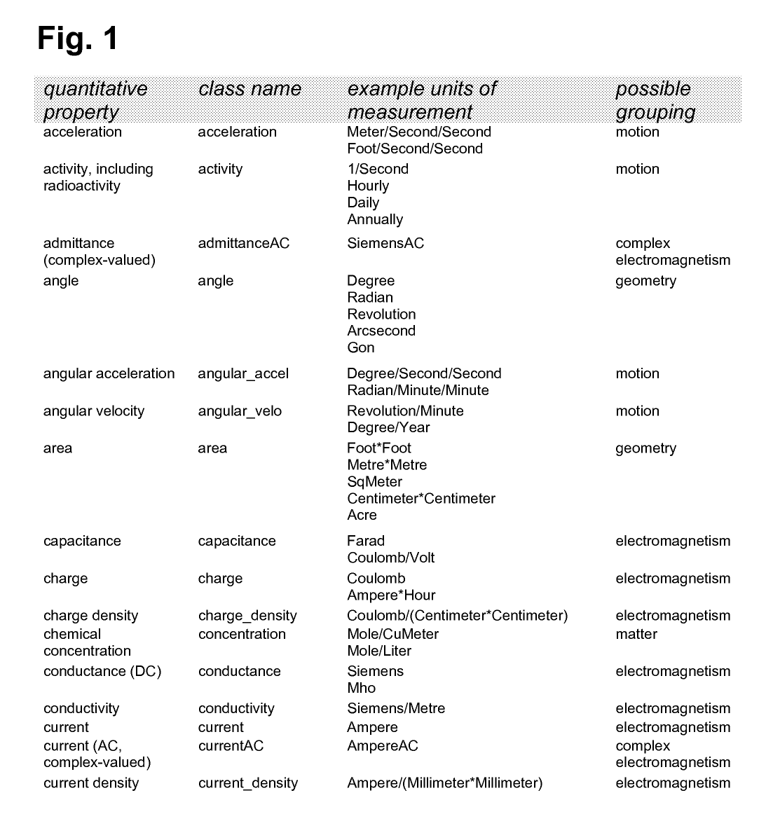

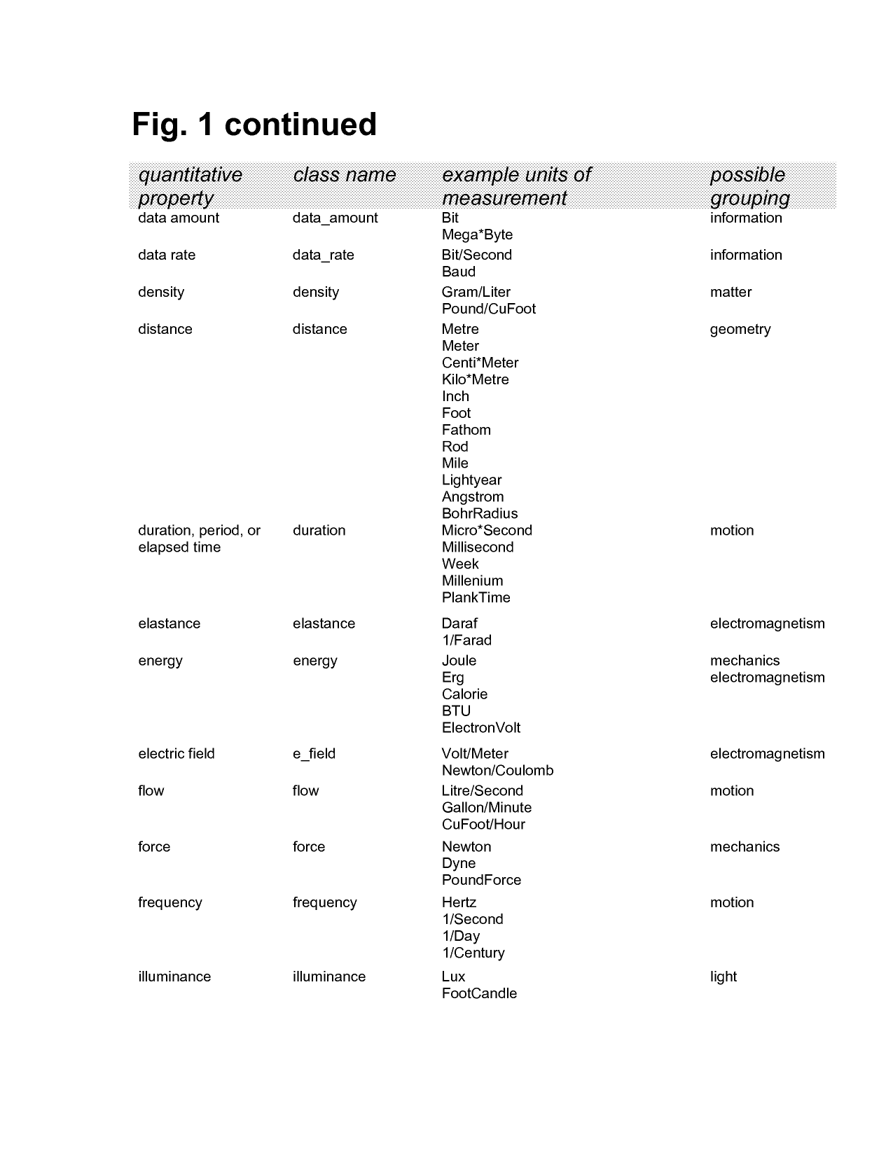

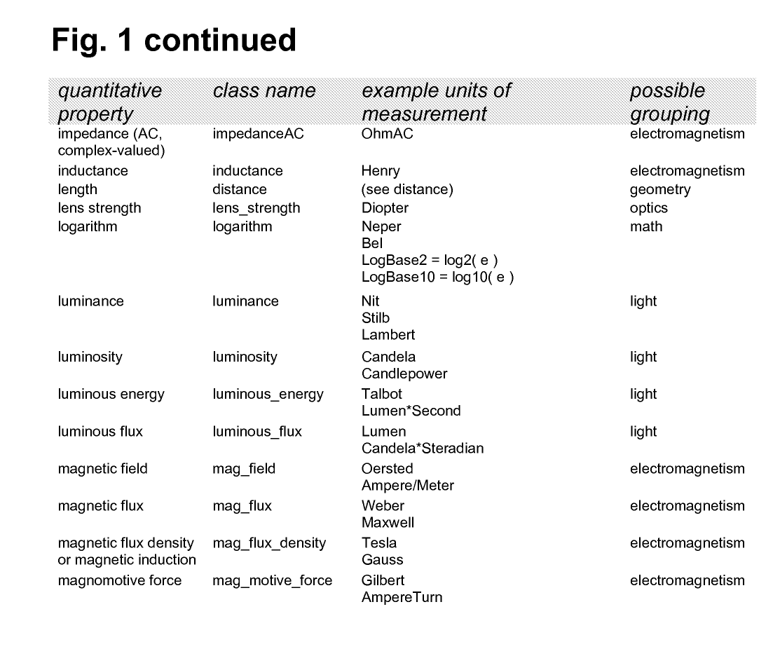

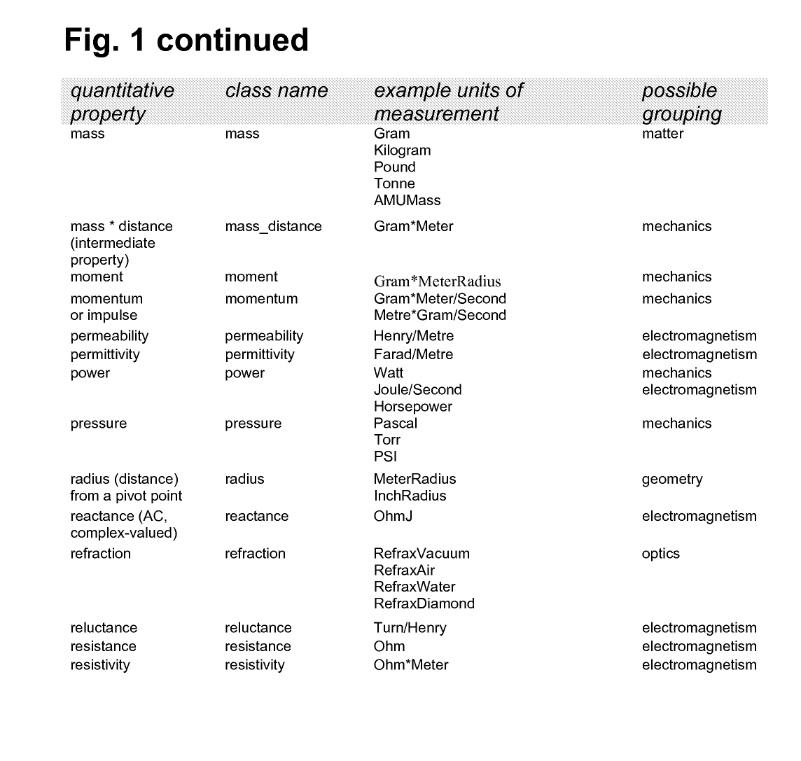

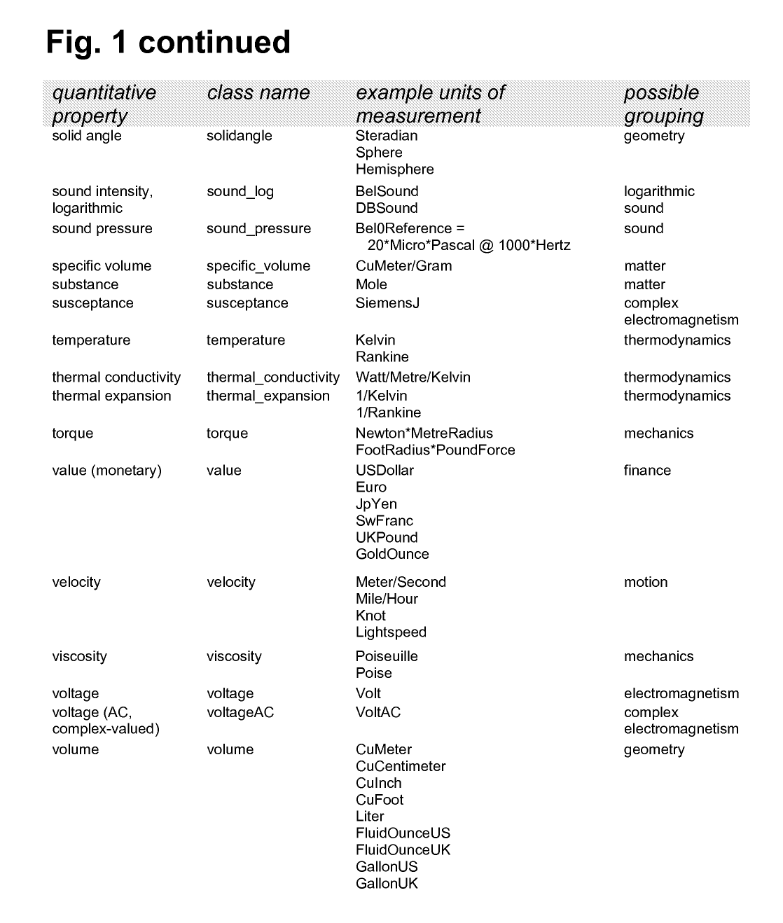

FIG. 1 is a table of examples of some typical quantitative properties (dimensions) which may be useful in engineering or scientific software. FIG. 1 provides potential names for classes to represent the properties and possible names for a few of their corresponding common units of measure. FIG. 1 also suggests categories into which the properties may optionally be placed. These categories may correspond roughly to different disciplines which generally focus on certain quantitative properties and not others. For example, electrical engineering would focus on the properties labeled with the category named ‘electromagnetism’; mechanical engineering on the categories named ‘motion’, ‘mechanics’, and ‘geometry’; and laser-based physics experimentation on the category ‘light’. The categories may be the basis for software library subsets targeted to distinct disciplines of science, engineering, and software applications.

Because each quantitative property corresponds to a unique class, a standard compiler (such as the Microsoft Visual C/C++ compiler) can validate at compile-time the type compatibility of the usage of objects of each class. Using this, an unmodified standard compiler can validate the “dimensional integrity” of computations (such as mathematical expressions) involving quantities’ objects of various property classes. That is, if the property classes are defined appropriately, a conventional compiler can validate at compile time whether source code statements and mathematical expressions conform to defined allowable calculations. The validation simply exploits the compiler's normal, built-in, strong type checking, which is performed during the parsing and translation of the source code which contains the statements and expressions. Otherwise, all of the details of the dimensional integrity are specified in source code definitions which the compiler compiles as input along with application source code which uses those definitions.

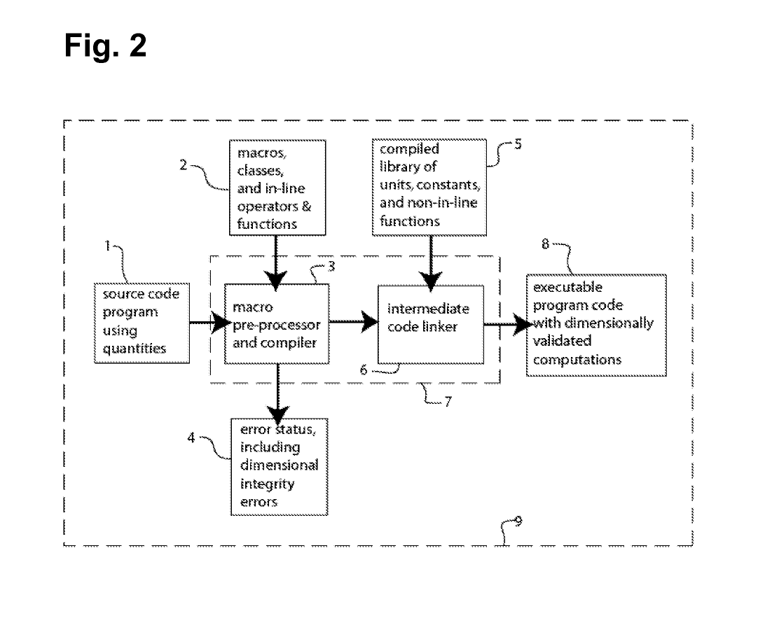

FIG. 2 is a block diagram indicating a typical computer programming setup on a computer 9. One or more source code program files 1 may be input into a compiler 3. Also input into compiler 3 may be or more “include” files 2 containing definitions of macros, classes, and in-line operator and functions. The compiler 3 may generate error status 4 in some human readable form, possibly including indications of dimensional integrity errors. The output from the compiler 3 typically is relocatable intermediate code, which is input into a linker 6, which combines the output from compiler 3 with one or more libraries 5 of previously compiled source code. The libraries 5 may include definitions of measurement units of one or more quantitative property classes and the bodies of non-in-line operators and functions. The output from the linker 6 may be a self-standing executable program 8 with dimensionally validated computations. Program 8 may then execute on the computer 9 or on another computer. Both compiler 3 and linker 6 are themselves executable computer programs executed within the instruction processor 7 of computer 9. The source code 1, include files 2, libraries 5, and executable program 8 all reside in the memory of computer 9.

For example, a program may be written in which a mathematical expression references a distance object D and a velocity object V, and in which the expression directs that those two quantities be added together, as in “D+V” for example. Then, when a conventional compiler (such as the Microsoft Visual C++ compiler) inputs and compiles the program, the compiler can detect the invalid, meaningless addition already at compile time. The compiler then can generate some indication of the invalid addition as a programming error. There is no need to perform the calculation or execute the compiled code to detect the error. Similarly, if the program includes a subtraction of an object of the class ‘area’ from an object of the class ‘mass’, the compiler can detect and generate an indication that the meaningless, invalid operation is an error. Normally only quantity objects from the same property class can be added together or subtracted from each other. Further, a quantity object (such as the result of a mathematical expression) may be assigned only to a variable declared to be of the property class of the assigned quantity. Similar strong object-oriented-typing constrains may hold for copy constructors, relational (comparison) operators, pointer dereferencing, array indexing, and memory allocation—operations typically available in an object-oriented programming language.

Which operations are valid are determined by the operators and functions which are defined to the compiler. Any operator or function in a mathematical expression in the source code which does not match an operator definition or a function definition is deemed invalid. Note that “match” means that the operator symbol or function name in an expression matches the symbol or name in the definition. Further, the classes of the actual operands (arguments) of the operator or arguments of the function must also match the classes of the formal parameters specified in the definition. In other words, this specification will take advantage of a feature now common in many object-oriented languages: namely operator symbol and function name overloading. For example, the addition symbol (+) may be used in various contexts, where its specific definition depends on the classes of its actual operands. As more particular examples, there may be a definition for using the addition symbol to add two distance operands to yield a distance object as the sum, but no definition would be given for using the addition symbol to add a distance to a temperature. In general, the addition symbol would have a definition for each quantitative property class for adding two quantity objects of the class together. Similarly, the subtraction symbol (−) would have a definition for each property class for computing the difference between two objects of the class. However, generally no definition would exist for an addition symbol to add objects of unlike property classes together or for a subtraction symbol to subtract objects of unlike property classes. There may also be multiplier operators (commonly symbolized as *) which multiply a unitless numeric scalar times a quantity object, such as “1.5*Volt” where Volt is a constant object representing a unit of voltage or electrical potential. Similarly, division operators may be defined for all property classes, in which a quantity is divided by a scalar, such as “I/2.0” where I is a variable of the class ‘current’. Of course, I could also be a more complex arithmetic expression which evaluates to an object representing a quantity of current.

The compiler would validate and allow a mathematical expression in which, for example, a distance quantity is divided by a time period quantity resulting in a velocity quantity. This assumes the compiler previously and explicitly compiled a definition of such a useful division operator (presumably symbolized by /). Similarly, the compiler would validate and allow the multiplication of a volume quantity with a density quantity to yield a mass quantity. This assumes the compiler previously input and compiled the definition of such a useful multiplication operator (likely symbolized by *) which takes volume and density objects as operands. Depending on the semantics of the language, one may need to define both ‘volume*density’ and ‘density*volume’ as separate operators.

The definitions of common arithmetic operators (such as operator symbols +, −, * or /) acting on operands belonging to specifically defined combinations of classes, may be conveniently located in a standard, predefined header or “include” file initially input to the compiler. Note that only an applied instance of an operator symbol in an expression and its actual operands which match (corresponds to) a previously and explicitly compiled definition of the same symbol and formal operand classes will be allowed as valid by the compiler. In a program containing any instance of an operator symbol and its actual operand classes for which there is no corresponding definition of the symbol and formal operand classes, a standard compiler will generate and output an error notification in some form at compile-time.

As well as arithmetic operator symbols, there may be various other mathematical functions defined, each function having specified property classes for the allowed argument(s) of the function. For example, there may be a square root function “sqrt” defined for any non-negative quantity of the ‘area’ class as the (formal) argument of the square root, where the result is a distance (length) object. However, there presumably would not be a square root function “sqrt” defined for an argument object representing a quantity of the property classes length, time period, voltage, or energy. There is no conventional interpretation for such a function. More generally, a compiler can use strong typing constraints to validate a more complex mathematical expression (formula) within the source code programs which it compiles. That is, the more complex expression may involve multiple or nested operators and functions in the expression, in which the operands and arguments may be simple constants or simple references to named quantity objects, or the operands and arguments may themselves be more complex mathematical expressions involving operators and functions.

For the purposes herein, a quantity of a quantitative, measurable property will be assumed to have a numerical ‘value’ with respect to some assumed ‘measurement unit’. The quantity may be represented by an object (or instance) of a specific object-oriented class (also known as an abstract data type) corresponding to the property. Each particular property may have one or more units of measurement. Each unit of measurement is a named object of the property's class. Generally each unit is a constant, and generally one such unit of each property is given the value 1. Each unit may be ‘constructed’ by constructor functions defined as part of the property's class. (Constructing an object in an object-oriented language generally means allocating memory for the object.) On processing the definition of the class and unit object, the compiler can generate executable code to construct and initialize the value of the object when the code is executed. This is the same as for any other class constant or variable object, which a program may declare and direct to be constructed. Although a program may define any number of additional measurement units in a program, an embodiment of the method and system generally would provide at least one pre-defined unit for each class representing the property of the unit.

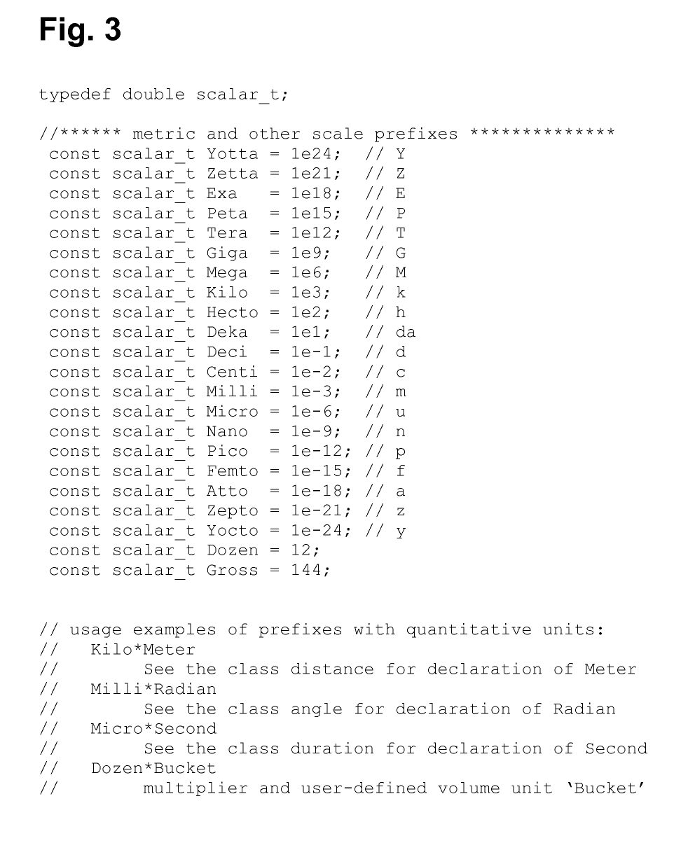

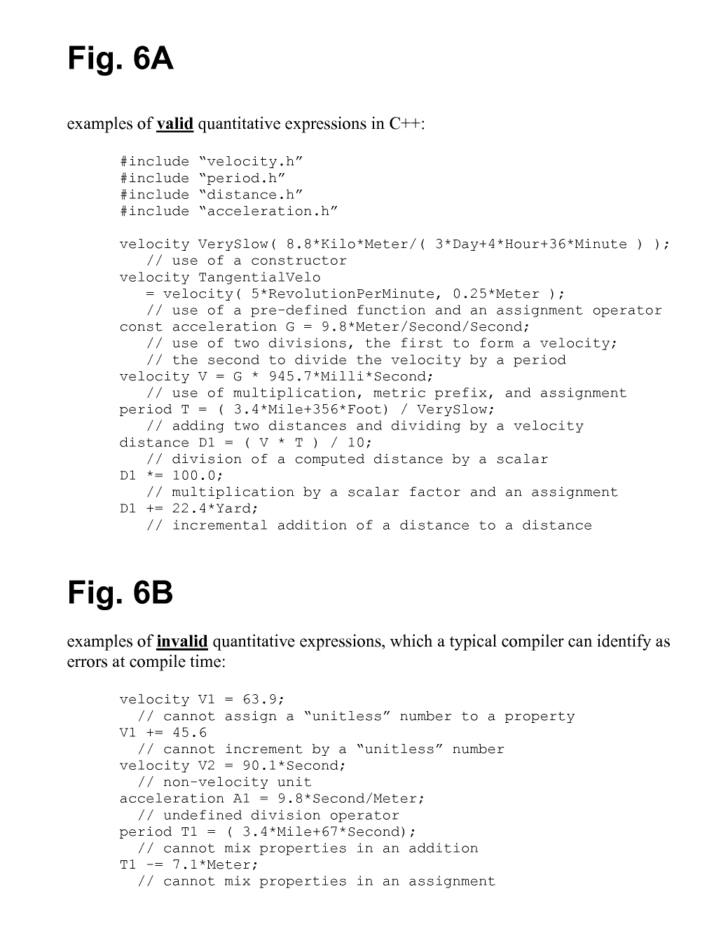

FIG. 3 lists the standard metric prefixes and their values, as defined in an embodiment expressed in the C++ programming language. These prefixes are intended to be used as constant scaling factors to be multiplied with various defined units of measurement. The use of some of these is illustrated in a subsequent figure (FIG. 6A). This approach avoids defining a plethora of unit names for all possible combinations of prefixes and base units. Otherwise, for just for one base unit of the distance property, for example ‘meter’, the system would then need to provide all the following units: Petameter, Terameter, Gigameter, Megameter, Kilometer, Hectometer, Dekameter, Meter, Decimeter, Centimeter, Millimeter, Micrometer, Nanometer, Picometer, Femtometer, Attometer, Zeptometer, and Yoctometer. Similarly, there may need to be 18 such named units for each of many other base units.

Instead of so many metric units for each property, the combination of the metric prefix “micro” and the unit “meter” can be written as the product Micro*Meter in a programming language, such as C++. Thus the method needs to define only 18 prefixes and only one name for each base unit of measurement. Nevertheless, source code utilizing the method can always define for convenience any of the following more common prefixed units, for example:

const distance Centimeter=Centi*Meter;

const energy Kilojoule=Kilo*Joule;

const period Microsecond=Micro*Second;

A few of such more common prefixed units may be predefined by a header file of an embodiment.

Note that in the examples immediately above, the metric prefix is simply the symbolic name of a scalar multiplier (such as the floating point number 0.01 for Centi). The subsequent figures will show that if Meter is defined to be an object of class ‘distance’, then multiplication by a scalar (such as Centi) is a source code expression which yields a run-time result which is also a ‘distance’ object. Similarly, in the definition of Kilojoule, Kilo*Joule is an ‘energy’ object, assuming Joule has been defined to be an energy object (presumably a measurement unit object in this case). Therefore, the value of a multiple of an energy object may be assigned to another energy object (a constant in this case). Similar comments apply to the time ‘period’ object Micro*Second.

Note that the embodiments of the Figures follow capitalization rules which parallel English. A class name is not capitalized—just like the common noun ‘woman’ is not capitalized. The name of a specific object instance, such as a constant, a unit name, or a variable is capitalized‘just as the woman's name ‘Judith’ is capitalized as a proper noun.

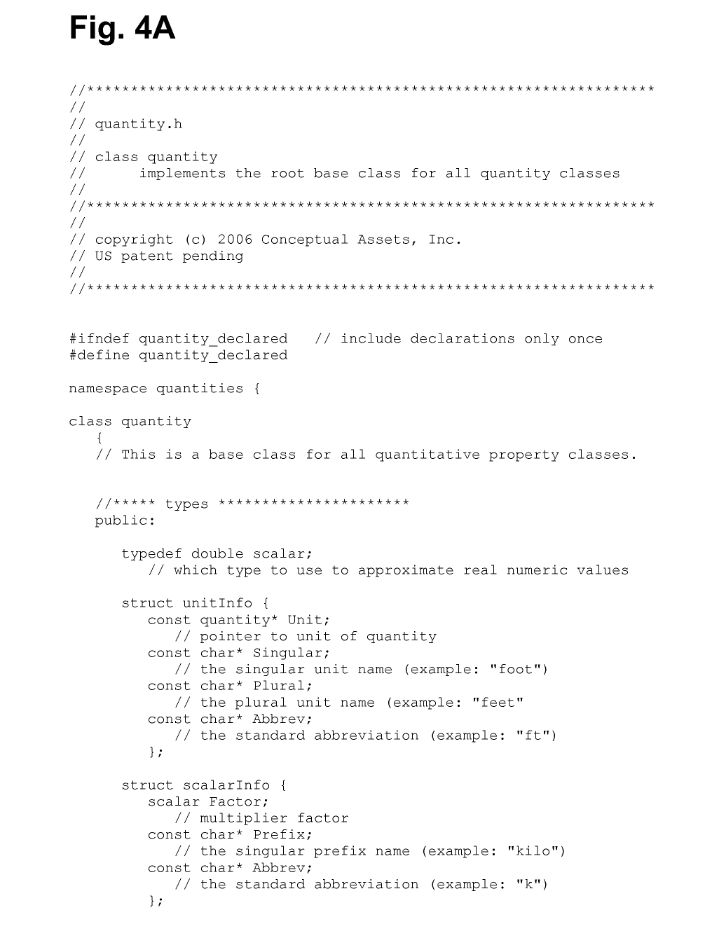

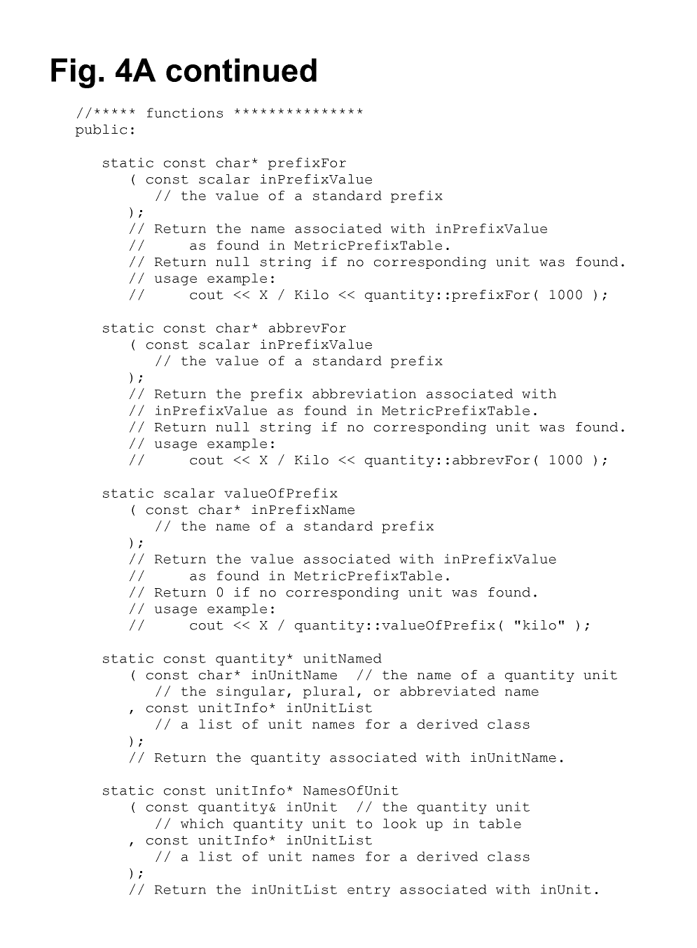

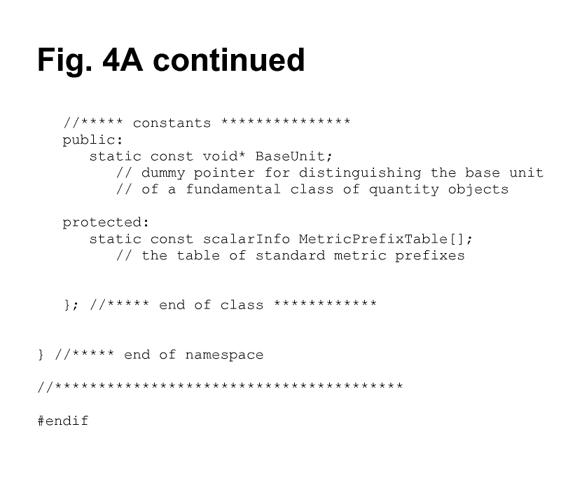

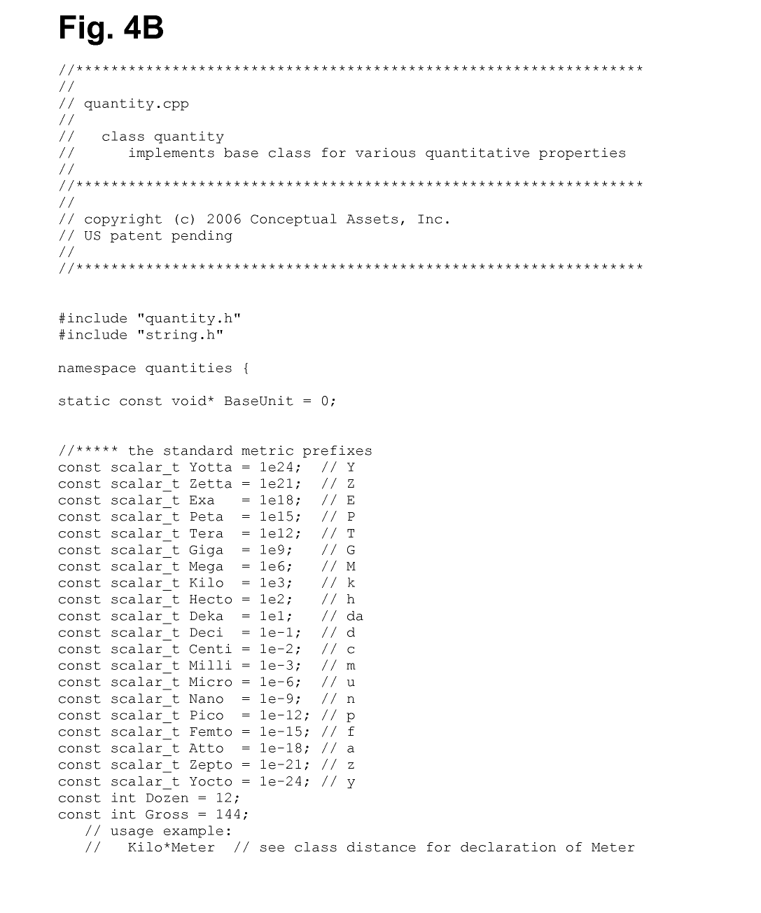

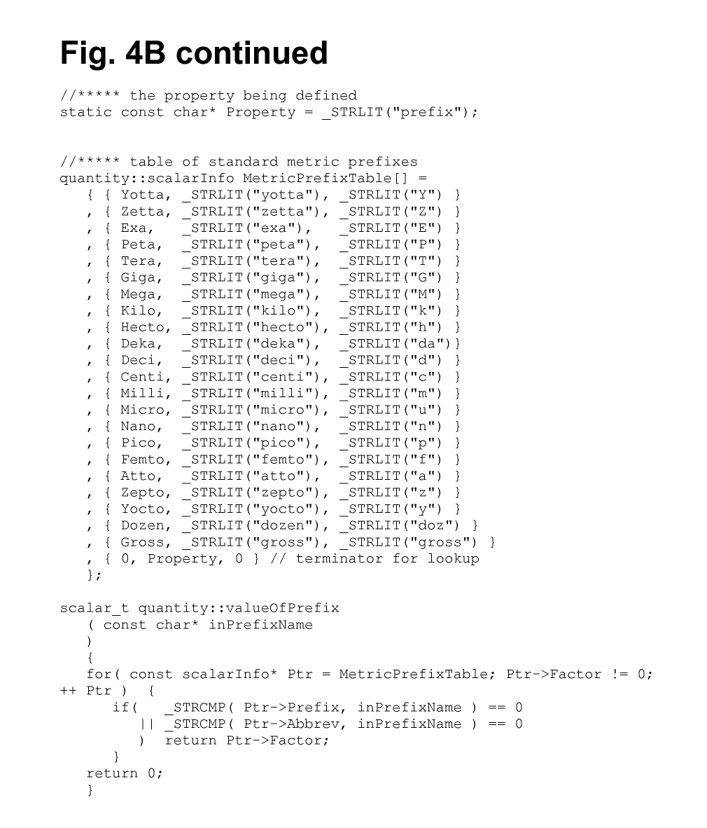

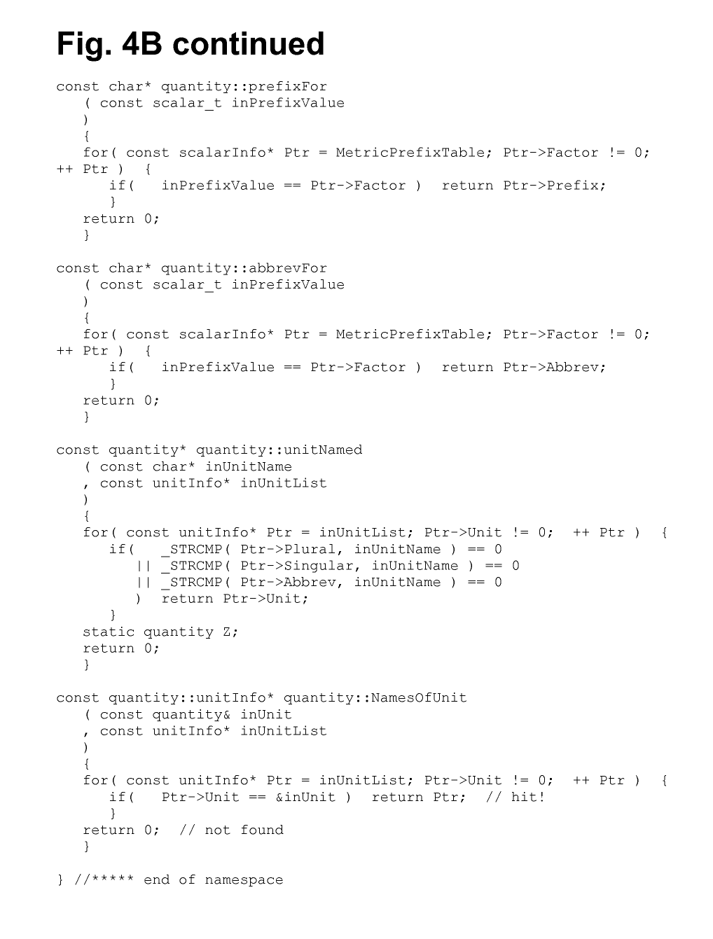

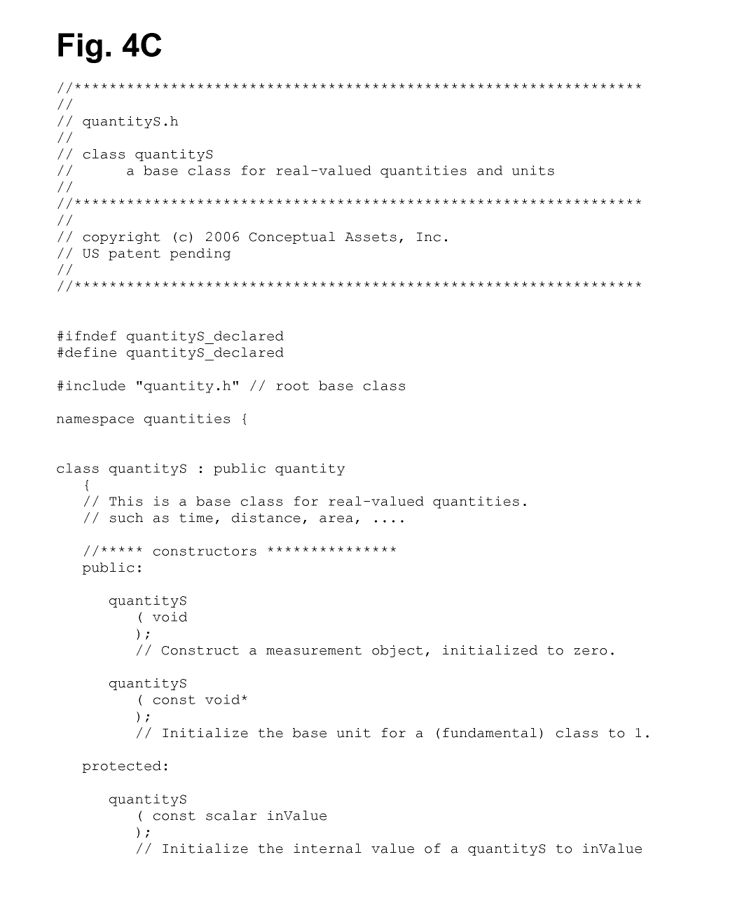

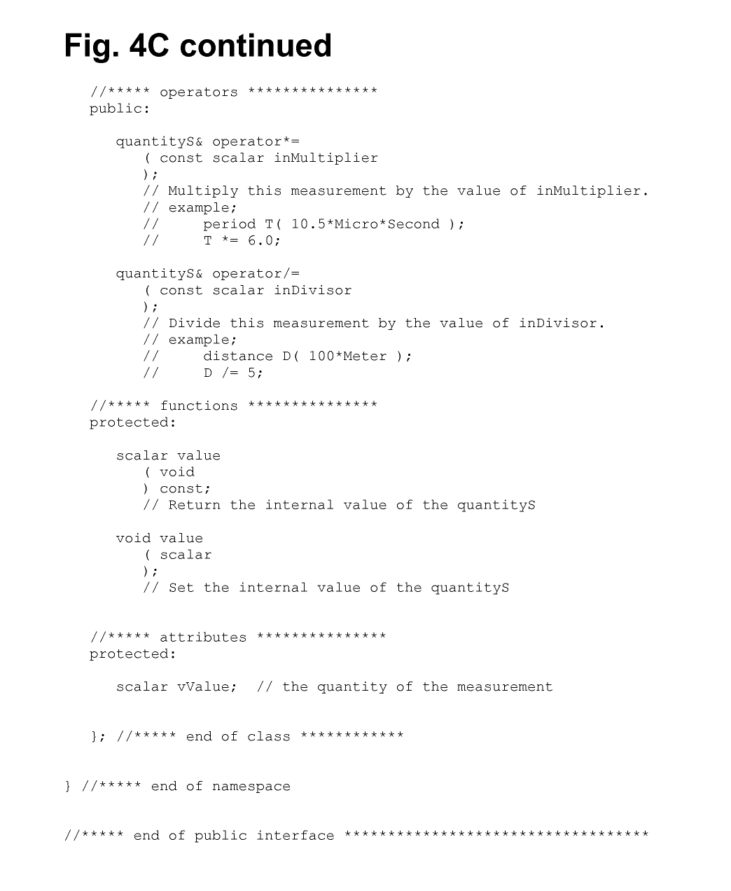

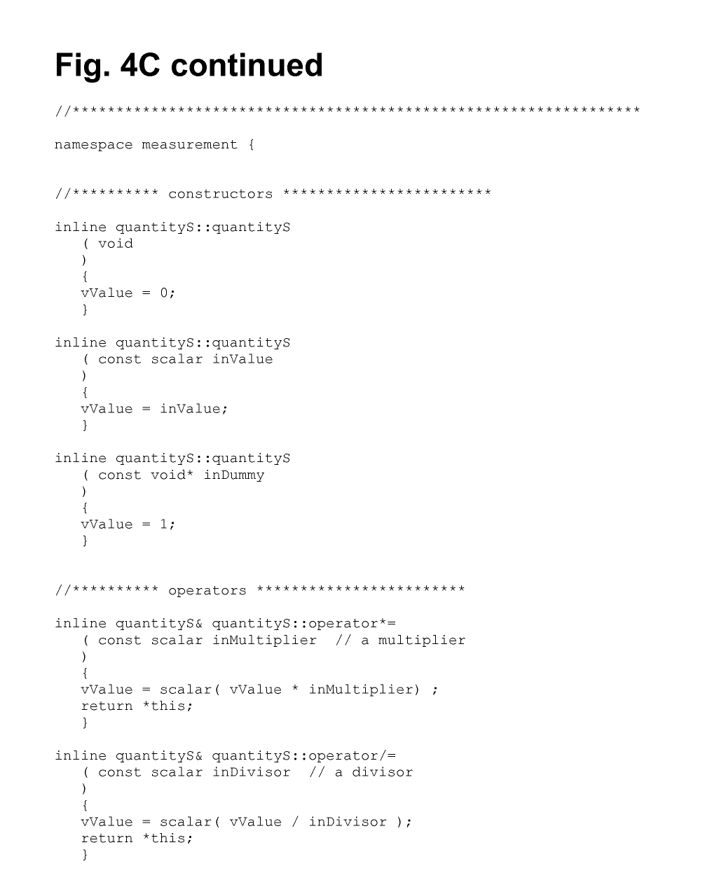

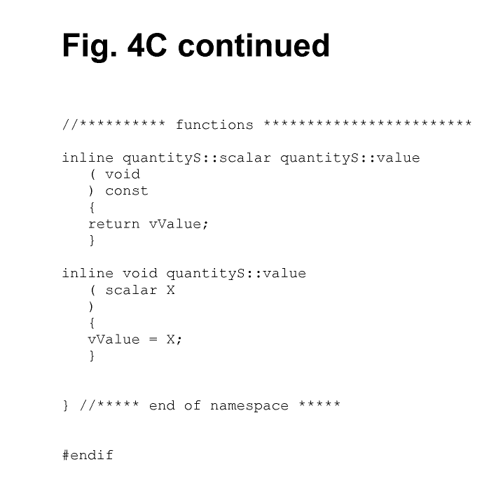

FIG. 4A is a header file listing of an embodiment implemented as a C++ base class called ‘quantity’, which contains declarations common to all the quantitative property classes which will be derived from it. The base class could be avoided of course, but the same common declarations and definitions may then need to be repeatedly reimplemented for every property class. The base class defines a numeric type called ‘scalar’ which can be used throughout the system of quantitative property classes. The type ‘scalar’ allows a user to change the numeric representation of all quantities in one place. The embodiments discussed herein all use the defined type scalar for their internal values, which in FIG. 4A is defined as a C++ ‘double’ precision floating point number. Instead, for example, it may be a C++ single-precision ‘float’. An alternative embodiment may allow each property class to customize the precision and type of its own values. However, the embodiments discussed herein all use the same numeric type and precision for their values, namely whatever type ‘scalar’ is defined to be. Using one common numeric type and precision throughout is reasonable, because in many applications quantities of various classes will compose various mathematical expressions in applied computations. The quantitative values resulting therefrom generally cannot have a true precision better than the lowest precision number used. Therefore, as a general rule, it may not be advantageous to use a precision for any one of the property classes which is greater or less than for any other property class.

Most of the source code of the embodiment of FIGS. 4A and 4B implements data structures and look-up functions which may be used by any classes derived from the base class ‘quantity’. The member functions and data structures implement associations between the units of measure and their corresponding textual character string names. This mechanism is intended principally for human-oriented input, output, and display. The names may be the English singular, plural, and abbreviated names of the corresponding units of measurement for each property class. Specifically in the case of the base class, the same mechanism may be used to associate the values of the metric prefixes with their corresponding English names and abbreviations. The unit names and the prefix names of FIG. 4B may be replaced or augmented by names in one or more other natural languages, such as German or French. The names may be strings of ASCII characters, Unicode characters, UTF-8 or UTF-16 encoded characters, or any other character set encoding. The functions may be used to look up the full character string name or the abbreviation of a unit, given the quantitative value of the unit, or vice versa.

FIG. 4B is source code for a C++ embodiment of the definitions corresponding to the declarations in FIG. 4A. The definitions include the actual internal values for the prefixes and the implementation bodies for the functions declared in FIG. 4A.

FIG. 4C is a source code listing of a C++ embodiment of a further base class called ‘quantityS’, which is derived from base class ‘quantity’ shown in FIGS. 4A and 4B. Class ‘quantityS’ contains further member declarations which are common to any linear, scalar-valued quantity class derived from ‘quantityS’. The declarations include object construction functions, assignment operators, and some value initialization and value returning functions. Some of the functions and the data member holding the value are protected, thus preventing public access to the internal implementation of the class. Such limitations on access are generally considered to be desirable practice among object-oriented programmers. However, there must be some way from the outside to designate which of potentially several declared named constant quantities will be the internal unit of measure for each fundamental quantitative property class. The definition of the designated unit may use the second form of the constructors-the one requiring the “void*” argument.

For example, for the property class called ‘distance’, there are many common constant units of measure, but Metre (SI spelling) will be the distinguished, internal standard unit relative to which all the others are internally defined. That choice is not a necessity, but was chosen to make the use of the SI system convenient. For example, the internal unit for the property ‘mass’ can be the gram, the kilogram, or even the pound (although the later may lead to unnecessary complication). The user of the methods herein need not be concerned about which measurement unit was chosen for internal use and generally does not even need to know. The following are example definitions which can appear in the implementation source code of the class distance:

//****** British spelling
const distance Metre( (void*)(0) ); // internal standard unit
const distance Centimetre( 0.01*Metre ); // for convenience
const distance Millimetre( 0.001*Metre ); // for convenience
const distance Kilometre( 1000*Metre ); // for convenience
//****** US spelling
const distance Meter( Metre );
const distance Centimeter( 0.01*Meter ); // for convenience
const distance Millimeter( 0.001*Meter ); // for convenience
const distance Kilometer( 1000*Meter ); // for convenience
//****** very large and very small units
const distance AstroUnit( 149597870691*Meter );
const distance Lightsecond( 299792458*Metre );
const distance Lightyear( 9.460528405e15*Meter );
const distance Parsec( 3.08568e16*Meter );
const distance Micron( 1e6*Metre ); // for convenience
const distance Angstrom( 1e−10*Metre );
const distance BohrRadius( 5.2918e−11*Metre );
const distance PlankLength( 1.61624e−35*Metre );
//****** English/US distance units
const distance Inch( 0.0254000*Meter );
const distance Mil( Inch/1000 );
const distance Foot( 12*Inch );
const distance FootSurvey( 1200.0/3937*Meter ); // US Survey Foot
const distance Yard( 36*Inch );
const distance Fathom( 6*Foot );
const distance Rod( 16.5*Foot );
const distance Chain( 20.1168*Meter );
const distance Mile( 5280*Foot );
const distance NauticalMile( 1852*Meter );
const distance League( 4828.032*Meter );
const distance NauticalLeague( 5556*Meter );

When source code containing the above definitions is submitted to a compiler (such as the Microsoft Visual C/C++ compiler), run-time code may be generated to construct each constant unit object—that is, at run-time to allocate memory for each object and to initialize its value as indicated by the parenthesized mathematical expression which evaluates (in this case) to an object representing a distance quantity.

Units other than the internal base unit may be predefined in a system-provided header file or library or may be added by a user. Normally one designated internal base unit will have the value 1.0, but it is otherwise not obvious to a user what is the protected (or private) internal value of any quantity unit or variable. This allows changes to the internal implementation of a property class to be made without affecting any programs which use the class. For example, the user does not need to know whether the unit for the internal values of objects of the property class ‘mass’ is the unit Gram or the SI standard unit Kilo*Gram or some other unit such as the pound.

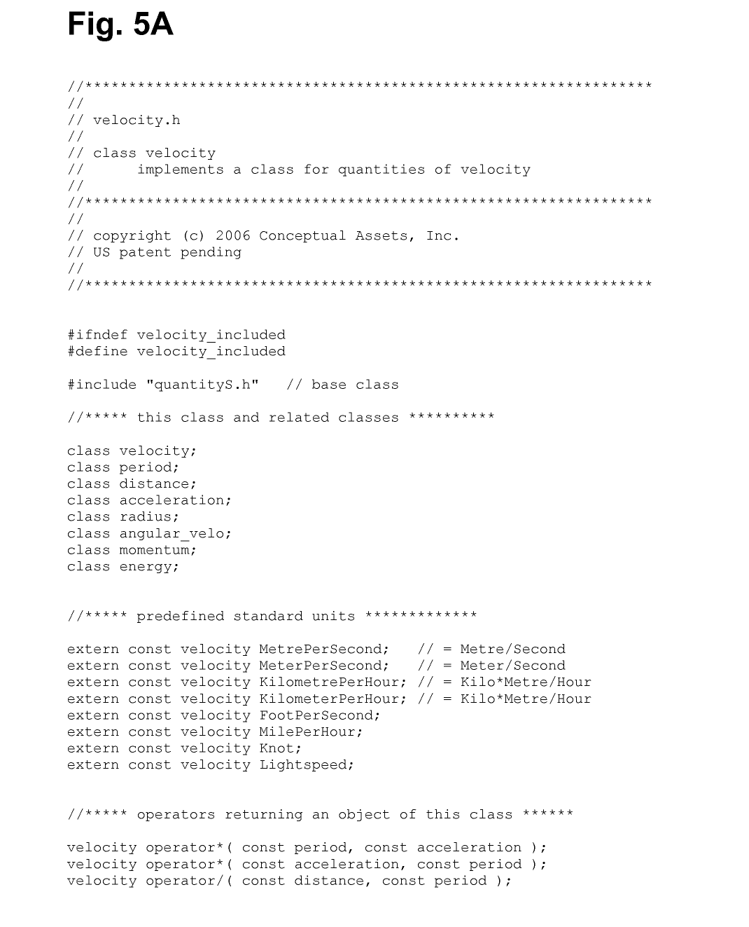

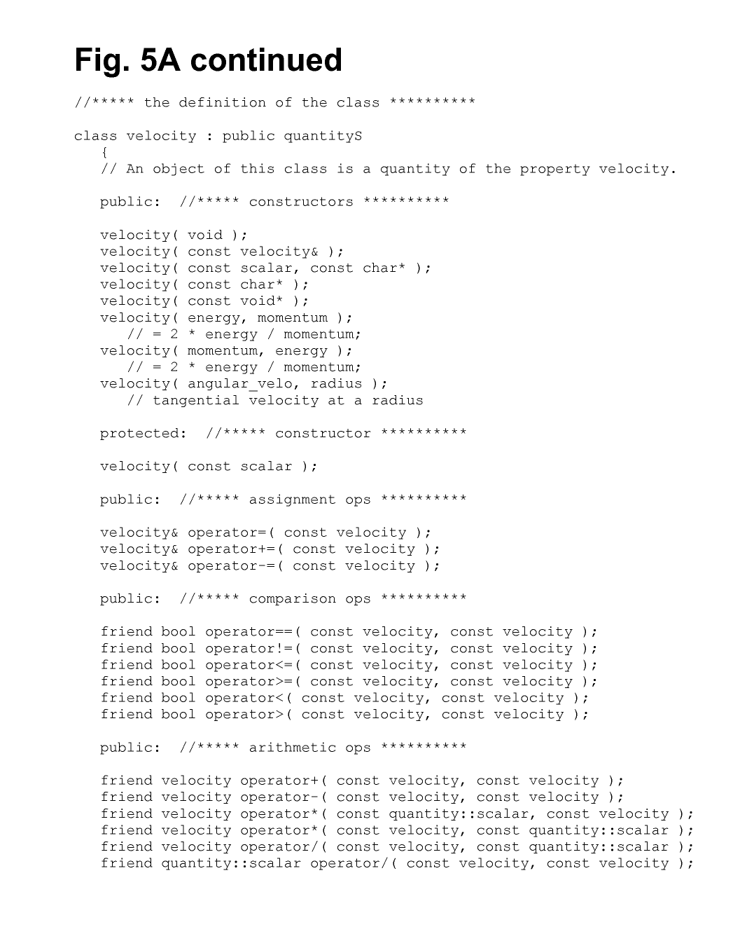

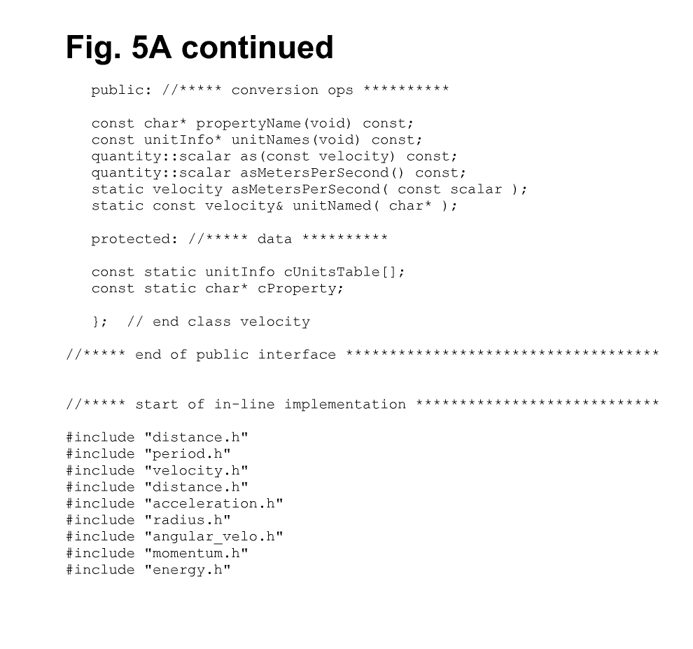

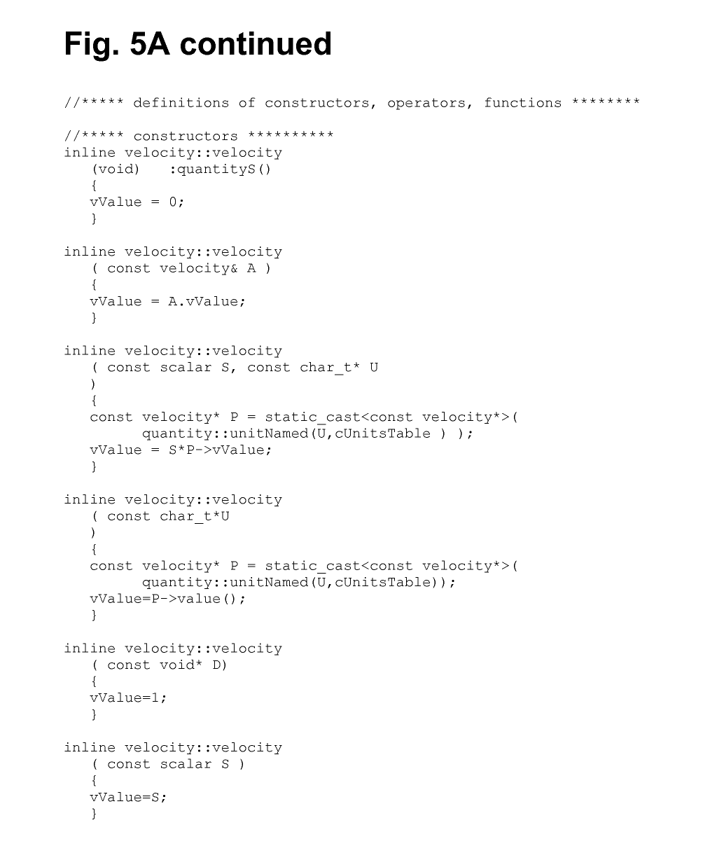

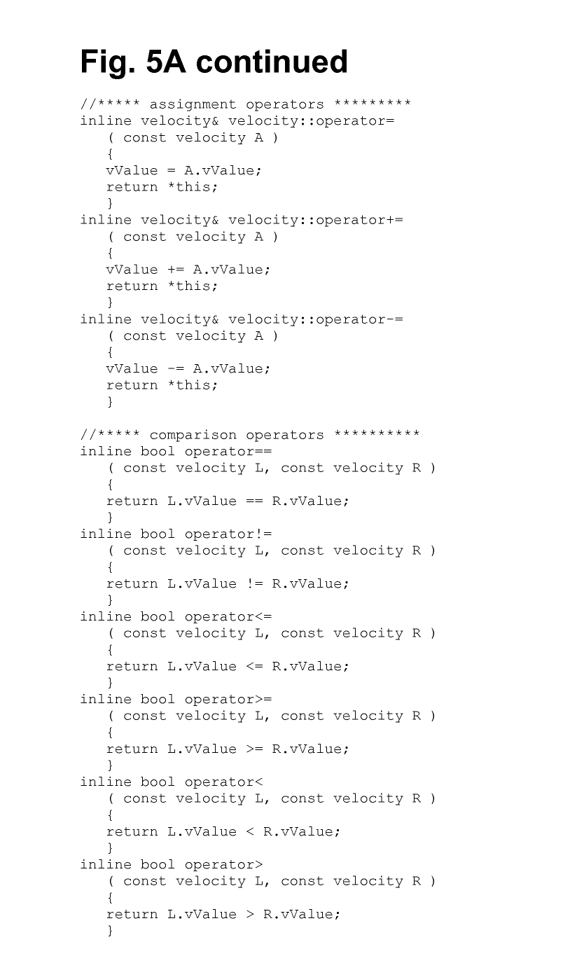

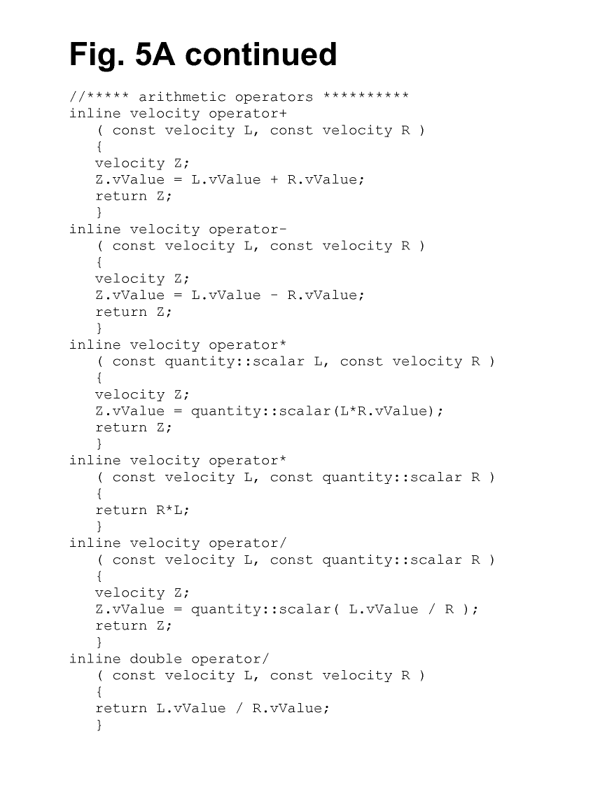

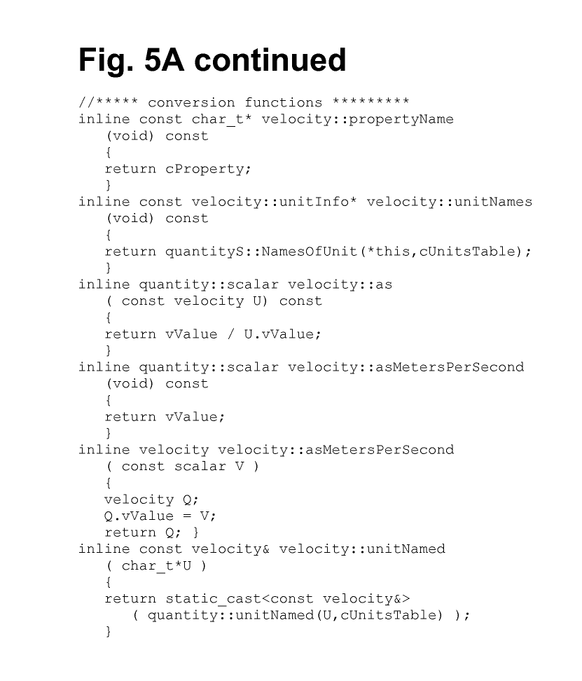

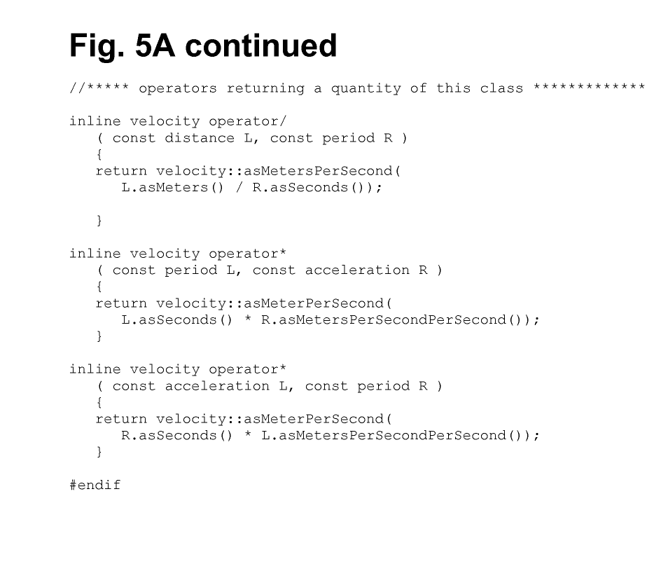

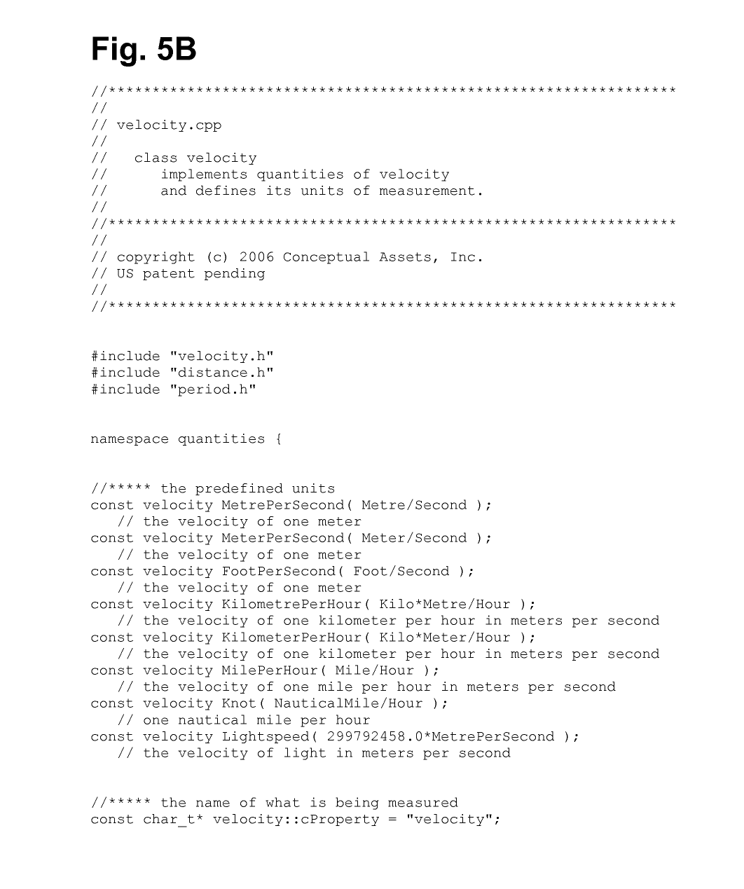

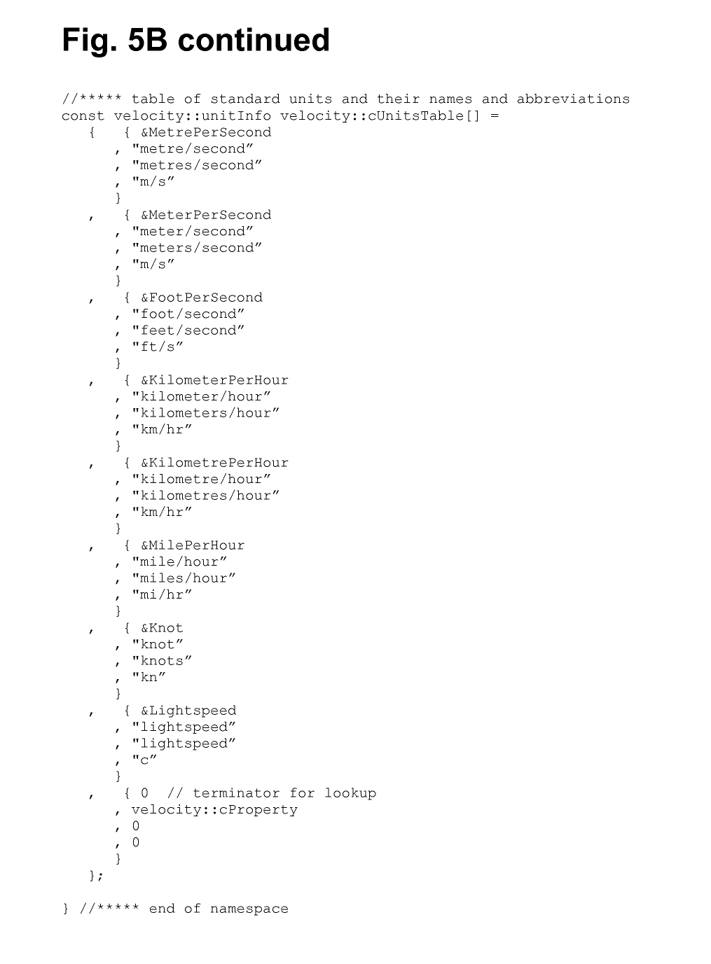

FIGS. 5A and 5B respectively are header and implementation file listings for a C++ embodiment of a definition for a class named ‘velocity’, which represents the specific quantitative physical property linear velocity as expressed in the C++ programming language. Note that the header file (FIG. 5A) is what is included within an application program employing the classes. Therefore, a compiler would input such definitions as part of compiling the source code of the application program including the definitions. In various embodiments, the implementation source code (FIG. 5B) may be previously compiled into an intermediate form, may be part of a relocatable object code library, and/or may not even be fully accessible to a user as a source code file. In the last case, a user may not readily determine which unit of measure of several defined units is actually used internally as the standard unit for a specific property class.

FIG. 5A defines a C++ embodiment of a class ‘velocity’ representing linear velocity. Note that a separate class may be defined for ‘angular velocity’, which is a distinct physical property. After including the base class for scalar-valued (real-valued) properties, ‘quantityS’, the source code embodiment in FIG. 5A declares the names of other classes representing related property classes. In FIG. 5A the embodiment code also declares the names of certain predefined units of measure, but the user may be allowed to define more units in a similar fashion. Then the embodiment source code declares the meaningful arithmetic operator symbols which compute acceleration quantities from actual operand quantities of other properties. For example, velocity is defined in terms of a distance operand divided by a period (that is, elapsed time) operand. (Note that the “placeholder” or “dummy” operands in an operator definition are called formal operands; the operands of an operator symbol used in an expression are called the actual operands.) In a like manner, a user of the method may freely define further operators having specific symbols and having formal operands belonging to specific classes, such that the operator presumably makes sense in some application context. These declared operators are in addition to the operators inherited from the base class quantityS. Any other operators or any other properties can be identified as illegal by a typical C++ compiler during compilation. However, further operator-operand combinations may be defined by the user. In the embodiment of FIG. 5A, additional constructors, specific to velocity and in addition to those of the base class ‘quantityS’ are declared. Also, various assignment, comparison, and arithmetic operators are defined and so are various conversion functions and name look-up functions. The conversion function asMetersPerSecond is provided as an efficient convenience for defining other metric properties such as acceleration. It does not necessarily imply that meters per second is the internal standard unit for velocity. The two static data declarations in the embodiment of FIG. 5A declare the unit names table cUnitsTable and the textual name of the property cProperty.

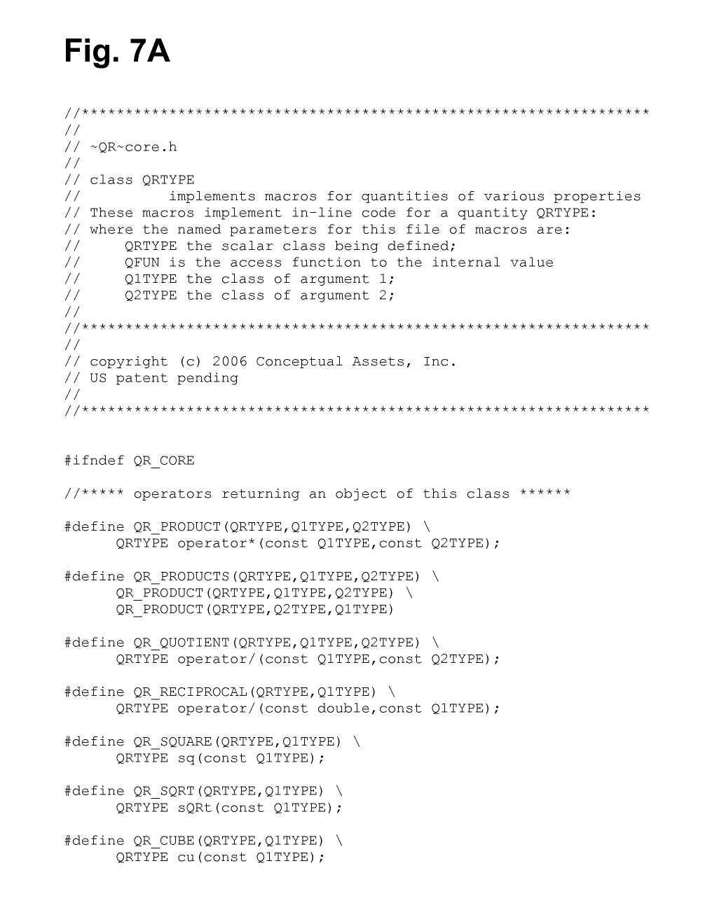

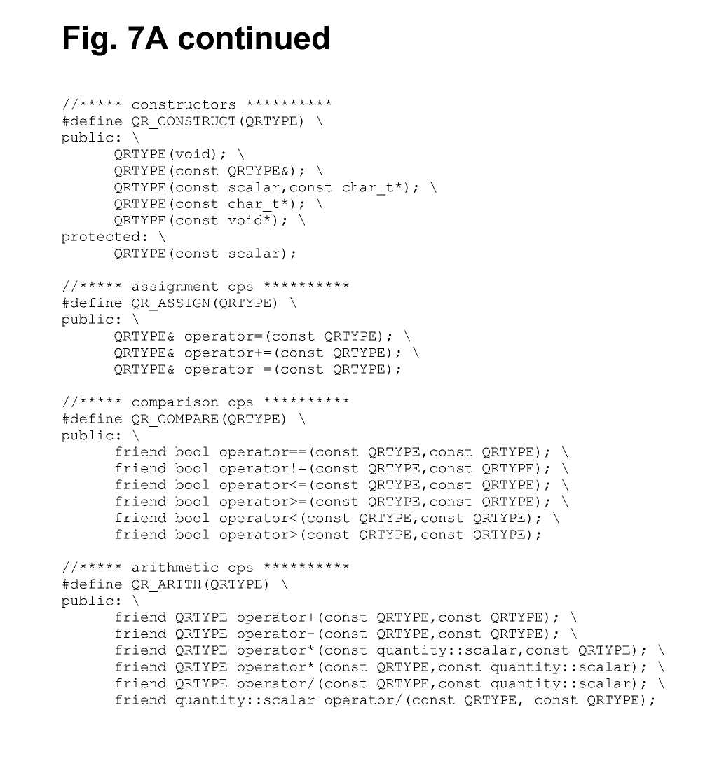

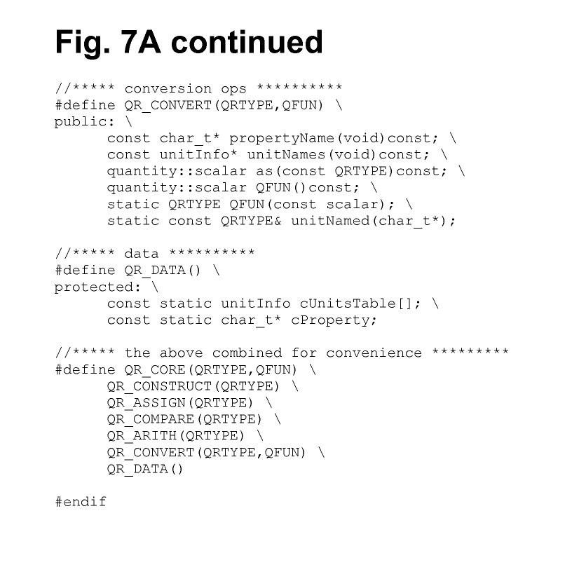

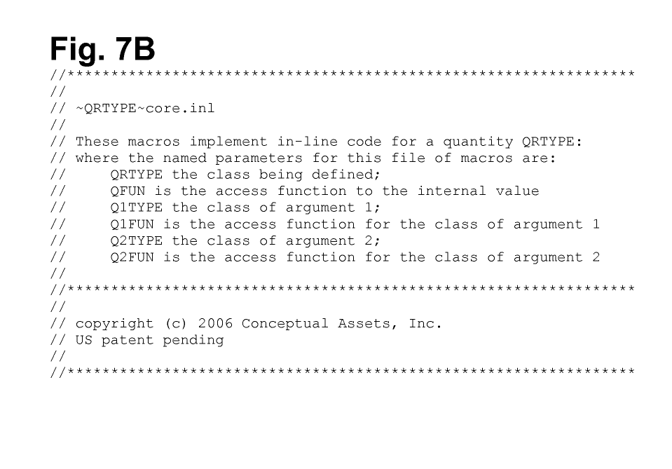

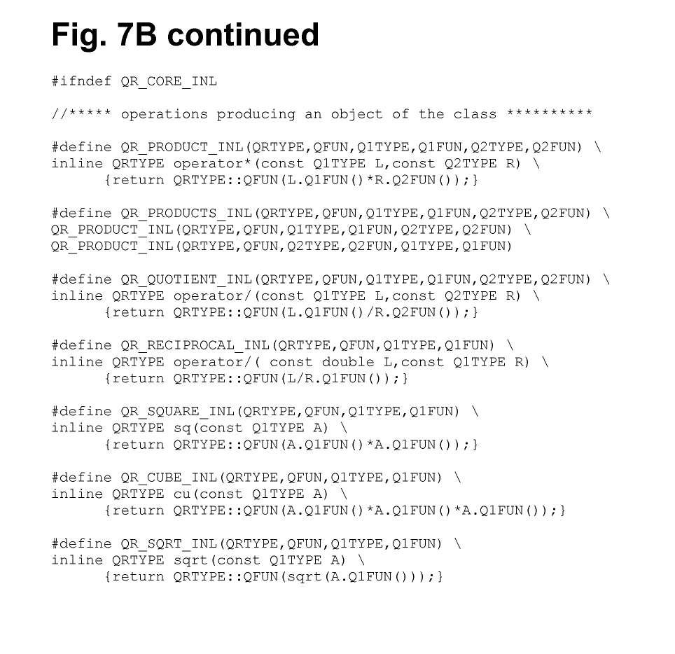

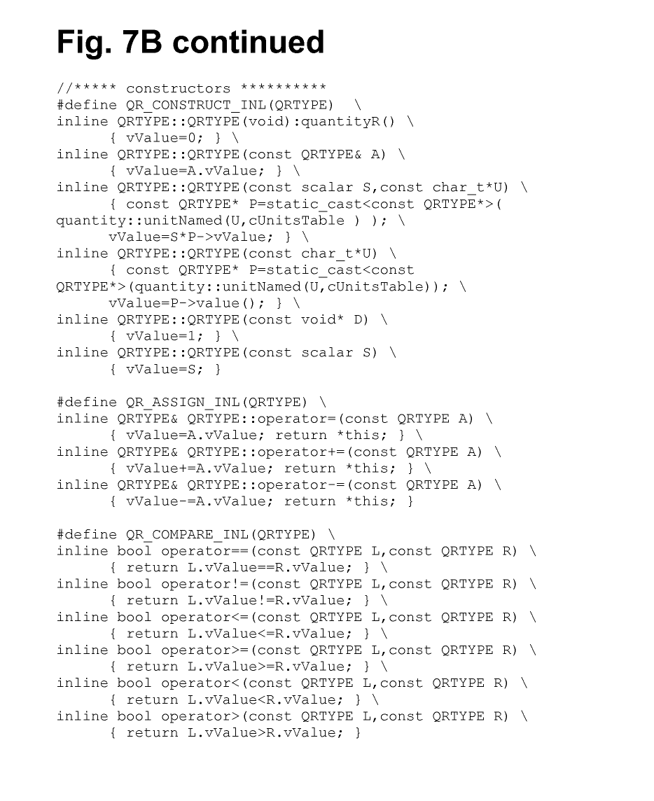

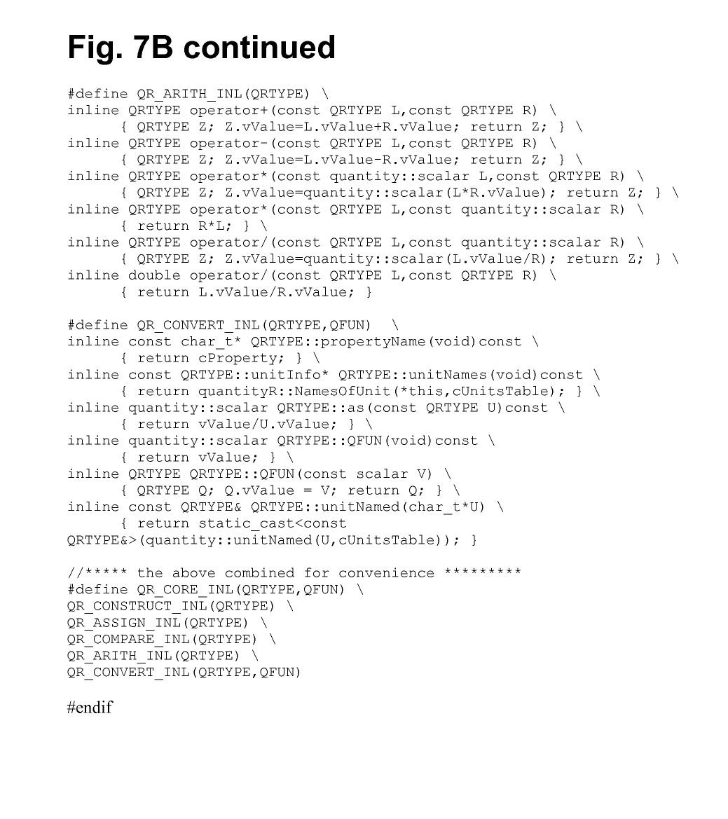

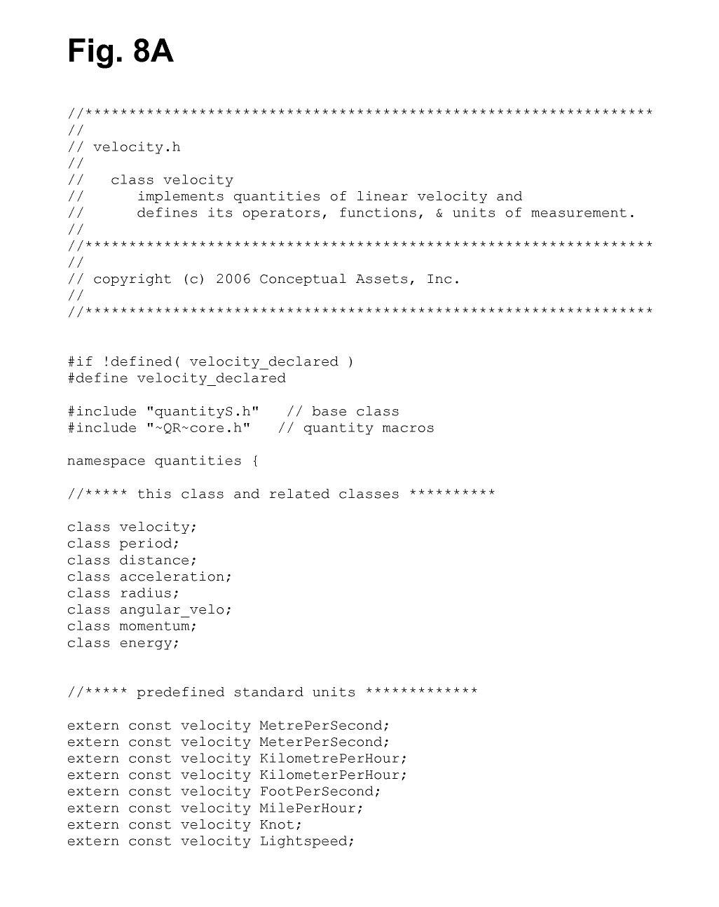

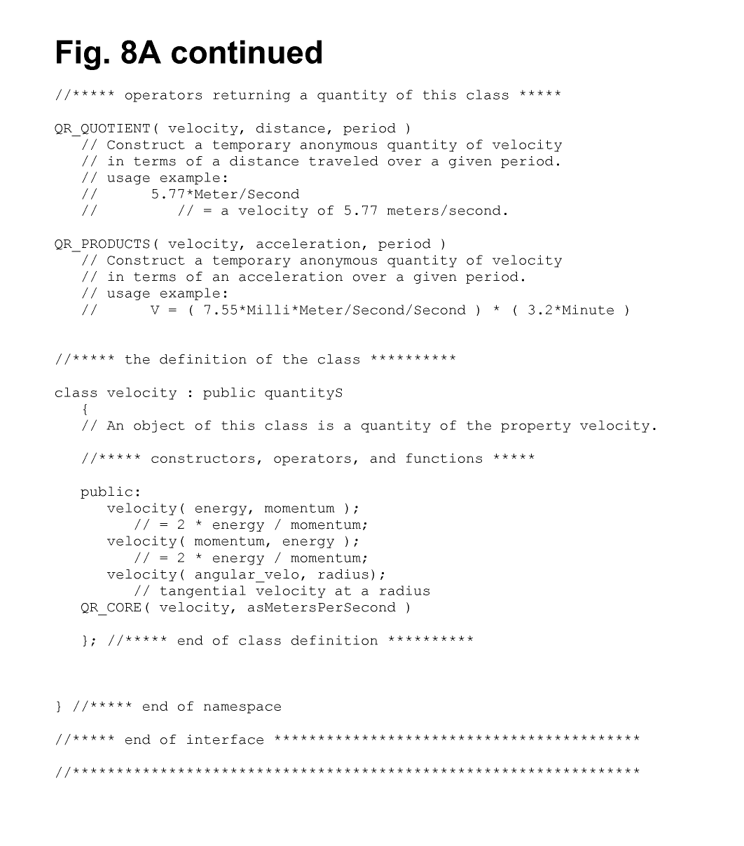

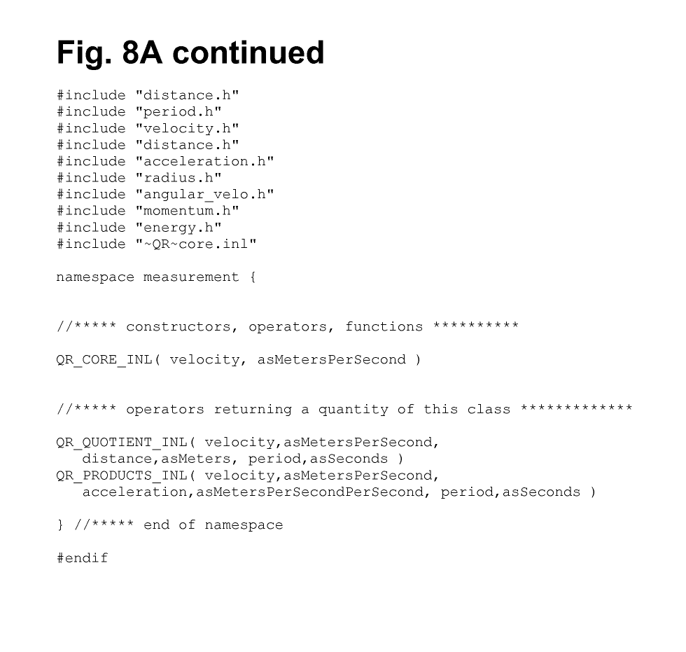

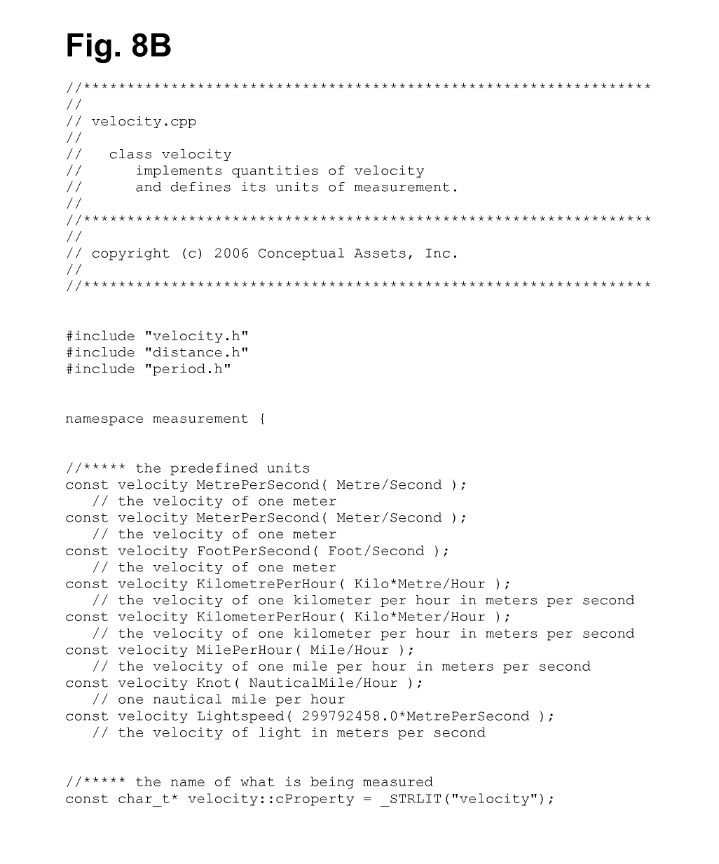

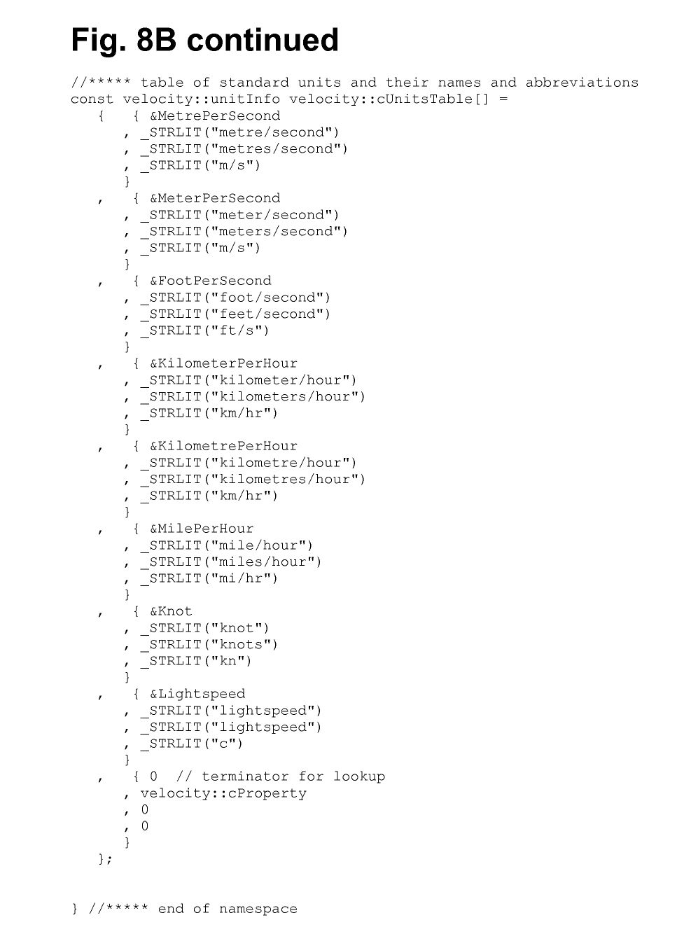

Classes for many other properties besides velocity, such as those of FIG. 1, can be defined in nearly the same way. One of the differences among them would be that distinct measurement units would be named and constructed and their values initialized. Subsequent figures (FIGS. 7A, 7B, 8A, and 8B) will show how this process may be automated and simplified through a method using parameterized text macros. That method will avoid the repetitious and error-prone effort of manually creating nearly identical lines of source code for each of the many properties. In any case, particularly note that any instantiation of any object of all the property classes (such as FIG. 5A) involves only one data field, namely vValue inherited from the quantityS class (FIG. 4C). The optional static members which form the look-up table (e.g. velocity::cUnitsTable in FIG. 5B) are allocated only one per class, not one per object. The data representation of individual objects could not be more efficient. No integer exponents exist to occupy extra memory per object at run time, as is required by many prior art methods and systems. Therefore, there cannot be any time-consuming run-time instructions executed to check or compute the non-existent integer exponents, which would otherwise represent fundamental base units. Extra memory or extra instruction execution at run time would be particularly costly for large arrays of data.

When a program, which utilizes the method described herein, needs to compute or write the actual numerical value of a property, the ‘as( )’ function may be used. A typical usage would be to output a numerical value in terms of a specified unit of measure. The following examples illustrate how a velocity quantity may be converted to or from a numerical value which is relative to a specific unit of measure:

```
velocity V = 120*Meter/Second; // initialized relative to m/s unit
double X;
  X = V.as( Mile/Hour ); // numerical value of V in miles per hour
  X = V.as( Centi*Meter/(Milli*Second) ); // numerical value of V in
  cm/ms
  X = V.as( Lightyear/Day ); // the value of V in yet another velocity unit
```

Unit conversion can take this form for all other property classes as well. So for classes representing mass and energy, for example, a program may contain statements such as these:

```
#include “mass.h” // a header file defining class mass and its units
#include “energy.h” // a header file defining class energy and the unit
Joule
#include “power.h” // a header file defining class power and a unit called
Watt
#include “period.h” // a header file defining class period and its units of
time double M, E;
M = (4.5*Kilo*Gram).as( Pound );
  // a conversion of a mass measured in kilograms to the same in pounds
E = (100*Joule).as( Watt*Hour );
  // a conversion of an amount of energy from joules to watt-hours
```

Of course the above source code snippet assumes that the header file “mass.h” includes the definition of a class which represents the property mass and was constructed in a way similar to how velocity was defined in FIG. 5A. Further, it assumes that the constant (unit) objects Gram and Pound were declared in “mass.h”, and presumably defined with constant values in a file “mass.cpp”, analogous to FIG. 5B. Similarly, a class energy and a unit object Joule may be defined in the header file “energy.h”. Note that Watt and Hour are units of power and (elapsed time) period respectively and are objects of the classes power and period and assumed to be defined in header files “power.h” and “period.h” respectively. Additionally, the above example code assumes that there is a defined multiplication operator which takes operands (class objects) belonging to the power and period classes respectively and returns an object of class energy. The header file “energy.h” would be one logical location for such a definition. In C++ the declaration of the operator can be

energy operator*(power P, period T);

For convenience the commutative form may also be provided:

energy operator*(period T, power P);

These statements are the way C++ declares multiplication of a power quantity times a time period quantity. An example of the use of this operator* in C++ is

5*Second*100*Watt

where 5*Second is a quantity of a time period and 100*Watt is a quantity of power. The inline bodies for these two overloaded operator declarations can be defined in a manner similar to the bodies of operator* in the last few lines of FIG. 5A. In these two example declarations, the operator* is defined specifically for operands P and T, which are formal operands, or formal parameters (“placeholders”), for run-time objects belonging to the classes power and period respectively. A library of property classes typically may contain numerous definitions for a multiplication operator and its symbol *, each dyadic operator definition operating on a distinct specified pair of operand classes. That is, each operator is uniquely characterized (defined) not only by the operator symbol, but also by the classes of its operands. Other examples of multiplication operators which may be declared similarly as above include

electrical resistance times current (returning a quantity of voltage),

voltage times current (returning a quantity of power),

mass times velocity (returning a quantity of momentum), and

power times period (returning a quantity of energy).

The various operators are defined by one or more statements which define how to calculate the result returned. Examples are shown in FIG. 5A. Similarly, there may be many operator definitions for division, that is, for operator symbol /, where each operator definition has a unique pair of dividend/divisor operand classes. FIG. 5A also shows an example for velocity defined by dividing a distance by a period (of time).

Many of the operators and functions declared in the embodiment of FIG. 5A are defined (implemented) as in-line code bodies. This allows a typical, off-the-shelf compiler to generate very efficient code—in principle, code which is just as efficient in memory space and execution time as if the computations were naively implemented in floating point arithmetic native to the compiler and computer. Because the source code bodies defining the in-line operators and functions normally must be available to the compiler, and only for this reason, the in-line definitions are included in the header (or include) file, instead of the implementation file (FIG. 5B). The header file embodied by FIG. 5A includes references to the header files of all property classes which provide operands and arguments to the in-line operator and function definitions respectively. The operator and function definitions (that is, the implementation bodies) themselves are very straightforward. Most definitions consist of only a single arithmetic operation. An embodiment may choose not to implement some or all operators and functions as in-line code. For example, some simple ‘subset’ C++ compilers may not support the in-line code facility, in which case the bodies must be implemented as normal function bodies, which would incur a small run-time overhead to pass parameters and call out-of-line code.

Note that the internal representation of an object of the class velocity (or any other class representing a scalar-valued property) is simply a number native to the compiler and computer for which the compiler translates source code. Thus, a velocity object requires no additional memory overhead a single native (floating point) number. Similarly, where an optimizing compiler does support an in-line code feature, the generated code requires no run-time overhead beyond the execution time required for computing with the numbers in the internal representation of the values of the objects (such as a single floating point instruction: add, subtract, multiply or divide).

Note that some compilers such as the Microsoft Visual C/C++ compiler provide a feature which “precompiles” the source code form of header (include) files into an intermediate form in order to later expedite compiling of application programs including the header file. Such a feature is still equivalent in principle to including the original source code header files.

FIG. 5B lists the source code of a C++ embodiment of the definitions which are not implemented as in-line code in FIG. 5A. The embodiment of FIG. 5B includes source code statements defining values of the units of velocity declared in the embodiment of FIG. 5A. FIG. 5B also includes the corresponding defining entries of the table of the character string names of the units of velocity. The exact (constant) unit values shown in FIG. 5B are taken from appropriate national or international standards organizations, where applicable.

Note that in FIG. 5B, the value of the internal unit for velocity is defined in terms of two other units, namely distance unit Meter and time period unit Second. However, distance and period are fundamental properties, so their internal standard units of measure, Meter and Second, are implicitly set to 1.00 by means of the constructor which takes a special reserved argument of (void*)(0). The user usually does not need to be award of which units are so defined as internal standard units. The user need never see the ccc.cpp implementation files, only the ccc.h header files which do not reveal the values of the units of class ccc. The user may not even be aware that the system is in the form of a packaged binary library plus header files, which effectively hide which unit is actually the internal standard unit for a property class.

Note that the method described herein does not explicitly distinguish which particular properties are “fundamental”, as does the SI system, in which the distinctions are somewhat arbitrary. For example, velocity could have been chosen as a fundamental property instead of distance, because one may argue that the velocity of light, c, is more fundamental in physics than distance. Then distance would be defined as speed times period (time). The same could be done in an alternative embodiment of the method described herein, because the method herein does not inherently depend on a certain fixed set of specific fundamental properties. The methods described herein may define an additional class representing any property as-yet unimplemented, for example, in a pre-packaged commercially available library of property classes.

FIGS. 6A and 6B respectively show examples of valid and invalid source code in C++ containing mathematical expressions involving quantities from several different classes, which in turn represent several well-known quantitative physical properties. The classes implementing those physical properties can be defined analogously to the class ‘velocity’. The valid examples illustrate a few of the ways in which application software may use quantities of various properties as operands (or arguments) within mathematical expressions to compute a quantity from those operand (or argument) quantities. Each invalid example is followed by a comment noting the reason for the error, for which a typical compiler would generate an error indicator or message. Most of the examples of errors involve some form of class (data type) mismatches. Note that a typical compiler would detect these errors at compile time. Hence there is no need for any run-time checks or exceptions (other than what may be already provided for the native number computation, such as division by zero and overflow). Note that FIG. 6A may not appear much different if written in Java, C#, or some nother object-oriented language supporting overloaded operators.

The valid example source code statements of FIG. 6A illustrate how the present method can be used in computations involving objects representing quantities in a program. A compiler can validate a simple or complex mathematical expression involving arithmetic operators and mathematical functions with respect to dimensional integrity at compile time. This assumes that the compiler is also supplied with a set of appropriate definitions for the operators and functions and definitions for the classes of their operands and arguments. If the compiler finds an expression to be valid, the compiler can compile the source code of the expression into executable code to evaluate the expression at run-time. A program using property classes generally will first include the definitions of all classes it references. Typically, the source code will direct that at least one object will be allocated or constructed at run-time, such as by declaring a variable of some property class. The object may be allocated in computer memory (global, heap, or local stack frame) or may be an anonymous object computed result of a mathematical expression (commonly implemented as a temporary object stored in a hardware register). FIGS. 5A, 5B, 7A, and 8A provide exemplary embodiments of several constructor functions, one of which the compiler will use to create the code to construct each and every object. (For the purposes herein explicit deconstruction functions are not required.)

FIGS. 5A and 5B illustrated a C++ embodiment for a specific quantitative property, namely ordinary linear ‘velocity’. Much of the source code for the velocity class will be very similar in form to that of many other scalar-valued property classes. This demonstrates that a parameterized pattern can be very useful to simplify the creation of classes for a variety of quantitative properties. FIGS. 7A and 7B illustrate such a parameterized embodiment in the form of two sets of parameterized C++ macros. One set of macros, as shown in FIG. 7A, is for function and operator declarations. The other set of macros, as shown in FIG. 7B, is for the in-line definition of function and operator code bodies. Each set of macros may be contained in a separate file, for example named respectively ‘˜qR˜core.h’ and ‘˜qR˜core.inl’. Most macros appearing in the declaration set of macros have corresponding macros in the in-line implementation (definition) set of macros. The various macros are defined with some or all of the following formal parameters, for which specific names are substituted when any of any of the FIG. 7A or 7B macros are invoked:

QRTYPE the name of the class being defined,

QFUN is the name of the access function to the internal value,

Q1TYPE and Q2TYPE are the classes of the first and second parameters, and

Q1FUN and Q2FUN are the access functions for the first and second parameters.

Invoking the macro QR_PRODUCT, as shown in FIG. 7A will generate the C++ declaration for the multiplication operator represented by the arithmetic operator ‘*’. Its parameters are the type of the result, QRTYPE, and the types of each of the left and right operands: Q1TYPE and Q2TYPE respectively. A specific example of invoking the macro QR_PRODUCT is

QR_PRODUCT( velocity, acceleration, time) in which QRTYPE is velocity, Q1TYPE is acceleration, and Q2TYPE is time.

Similarly, invoking the macro QR_QUOTIENT will generate the C++ declaration for the division operator represented by the arithmetic operator ‘/’. The macros QR_RECIPROCAL, QR_SQUARE, QR_SQRT, and QR_CUBE are special cases which generate declarations of operators or functions which respectively compute the reciprocal, square, square root, and cube from an argument quantity of a different class.

The embodiment shown in FIG. 7A includes a macro QR_CONSTRUCT, which can be used to generate several common constructor declarations for a class. QR_CONSTRUCT has as its formal parameter QRTYPE, which is the placeholder for an actual argument—specifically, the name of the class being defined. Similarly, using the macros QR_ASSIGN, QR_COMPARE, QR_ARMTH, and QR_CONVERT will each define several C++ operators or functions, which respectively assign, compare, compute, or convert quantities of a class or classes. Macro QR_CORE is defined to call each of QR_CONSTRUCT, QR_ASSIGN, QR_COMPARE, QR_ARITH, and QR_CONVERT in turn to fully declare the class for a quantitative property. (QR_CORE was subdivided into those five constituent macro calls solely for convenience. Alternatively, the corresponding bodies of those five constituent macro calls could replace their calls and form one monolithic body for QR_CORE, for example.)

The embodiment shown in FIG. 7B includes macros for defining the bodies (implementations) corresponding to the operators and functions declared in the embodiment of FIG. 7A. Because the bodies involve very simple code and because they are defined as in-line, an optimizing compiler can generate code which is as efficient as code which performed the same calculations using built-in numeric values of the equivalent type and precision. Note that if a programming language compiler does not have a built-in facility for processing text macros, as C++ compilers normally do, one can still employ the methods of this specification. For example, one can apply a common text editor to a copy of each macro in order to do mass replacements of the macro parameters with actual arguments.

Note that the template mechanism of C++ language was not used to define property classes in the embodiments of the Figures. This is because the C++ template mechanism can only parameterize a generic class which already has a name, but the mechanism is not appropriate for directly defining a set of new classes each with a new simple name of its own. Furthermore, not all programming languages provide a template mechanism like that of C++. However, any separate text macro processor or editor may be used to manually and permanently expand the macro calls and their parameters into normal source code for a programming language without built-in macro capabilities. In any case, the C++ preprocessor macro facility seemed to provide a more capable way than templates to provide parameterized patterns for easily defining a set of property classes.

The template mechanism can certainly be used to parameterize the precision of the values of objects of property classes, for example—particularly in a case where each property class is to have its own explicit individualized precision. Thus, in an alternative embodiment employing the template mechanism, a programmer can declare two different velocity variables of different precisions, as in the following:

velocity<float> V1;

velocity<double>V2;

The embodiments of the Figures avoided this parameterized template approach to keep the description and source code simpler to understand. The classes can alternatively be defined using parameterized templates in an alternative embodiment. The alternative embodiment can be derived from the Figures, for example, by a straightforward replacement of the ‘scalar’ data type with a template parameter ‘<scalar>’ and adding other appropriate required keywords and syntax as needed to define a template.

FIGS. 8A and 8B list source code for a C++ embodiment of an alternate definition for a class named ‘velocity’, which uses the macros of FIGS. 7A and 7B. Note that the macro calls of FIGS. 8A and 8B, together with the macro definitions shown in FIGS. 7A and 7B would result in intermediate, generated source code essentially equivalent to that of FIGS. 5A and 5B. An advantage of using the macro approach is that there now is a way to compactly represent and easily generate a large suite of quantitative property classes having scalar-valued, linear quantities as their objects. Furthermore, this approach may be less prone to errors, because only one significant piece of source code (namely the macro body) needs to be debugged and maintained.

A number of details in the embodiments of FIGS. 7A, 7B, 8A, and 8B are convenient but not essential to the method, and the embodiments may be implemented in alternative ways. One unessential detail is the use of the C++ namespace feature, which may not be available in some compilers. An alternate method of avoiding clashes with the user-defined names (identifiers) within user programs can be to prefix all the public identifiers of the quantity classes with some unique prefix, such as ‘quant_’. The prefix can be appended to the names of all the quantity classes, their units of measure, and the associated functions to avoid name conflicts with named entities in application software employing the present method. In effect, ‘quant_’ would replace the ‘quantities::’ qualifier.

The in-line operators and functions can alternatively be implemented as ordinary function bodies, but in that case most compilers may generate slower code.

Further, the table and functions for looking up the external character-string names of the pre-defined units are an optional, convenient feature, are not essential to the methods herein and a system using the methods. The table and functions may be omitted.

There may be other constants defined besides the usual units of measure for a class. For example, a class abstracting the quantitative property ‘density’ can include pre-defined constants for the density of many different materials, such as water, other liquids, various metals, gemstones, and other solid elements and compounds. These may be defined for a specific combination of a standard temperature and a standard pressure or for a variety of temperatures and pressures. Furthermore, client software may include functions which compute an approximation to the density as a function of temperature and pressure quantity arguments.

One quantitative property of particular interest is angle. Because of the importance of trigonometric functions, it would be meaningful to define a full set of trigonometric functions which take angle objects as arguments—instead of or in addition to the usual trigonometric functions which take native floating point numbers as arguments. The functions can include sine, cosign, tangent, cotangent, secant, and cosecant. The results of the functions may still be native floating point numbers, because the results of those trigonometric functions are “unitless” ratios. Also the corresponding inverse trigonometric functions may be defined, which functions can return objects of the class angle instead of native floating point numbers.

Another particular quantitative property of interest is ‘radius’, which may be considered distinct from ‘distance’. Consider the ambiguous SI measurement called a newton•meter. It may be a newton of force applied at a meter radius perpendicular to the radius to yield a quantity of torque. Alternatively, a newton•meter may be a newton of force applied parallel to a distance of one meter to yield a quantity of energy (or work). Within the methods and system presented herein, the two properties may be distinguished respectively as a Newton*MeterRadius of class torque and Newton*Meter of class energy, for example. In this example, Newton is a unit of force, MeterRadius is a unit of radius from a pivot or fulcrum, and Meter is a unit of linear distance. When energy, torque, force, radius, and distance are distinct classes, and when only meaningful operators and functions are defined and allowed, then a compiler can validate whether mathematical expressions involving them are valid. In this way the compiler automatically validates “dimensional integrity” using the strong-typing method presented herein.

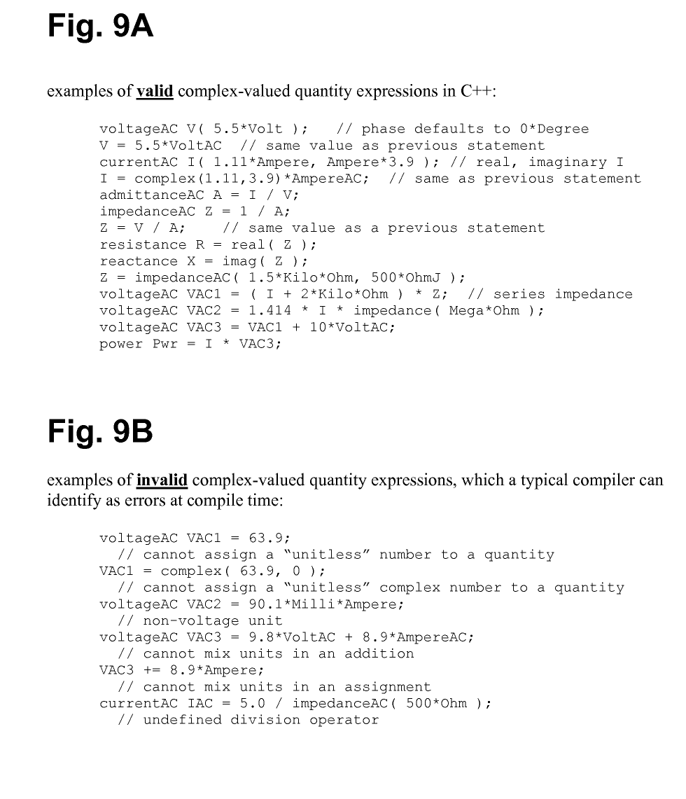

FIGS. 9A and 9B show valid and invalid examples of AC electrical computations involving complex-valued quantities. Sinusoidal and other periodic currents and voltages are commonly represented as complex numbers in electrical engineering. Furthermore, the composite impedance or admittance of a circuit comprising resistance, inductance, and capacitance may also be represented as a complex number. These numbers are associated with quantitative properties, which may be represented as complex-valued quantities of object-oriented software classes. With respect to electrical properties in particular, a complex, AC form of Ohm's Law relates these quantities in the form of complex division and multiplication operators defined in connection with the complex-valued classes. Further operations or functions may be defined to combine two impedances which are in series or which are in parallel to compute the resultant impedance.

Because the macros of FIGS. 7A and 7B provide a mechanism for compactly defining a suite, or a library, of scalar-valued property classes, the same approach can be used for a library of complex-valued property classes, such as AC voltage, AC current, impedance, and admittance.

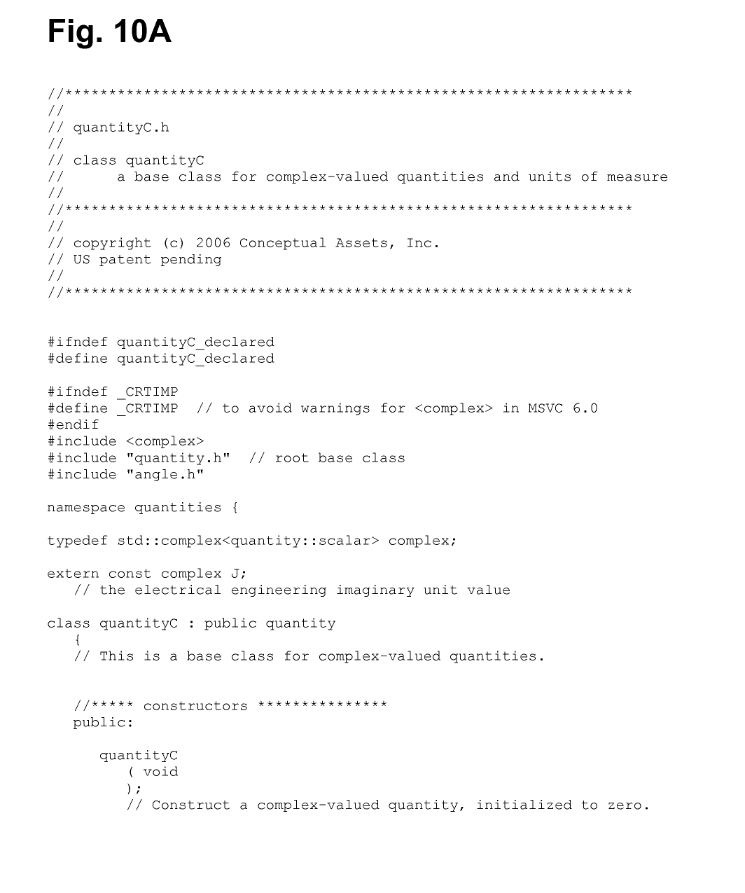

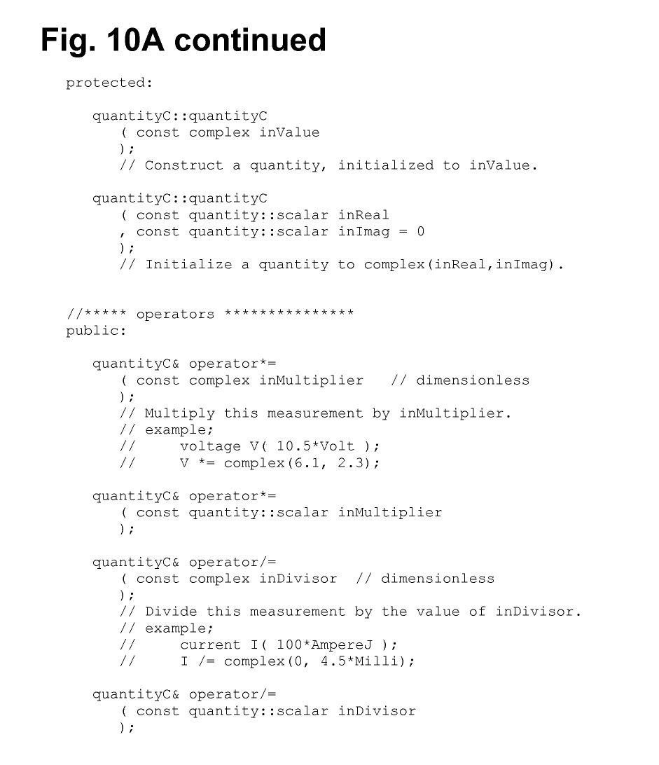

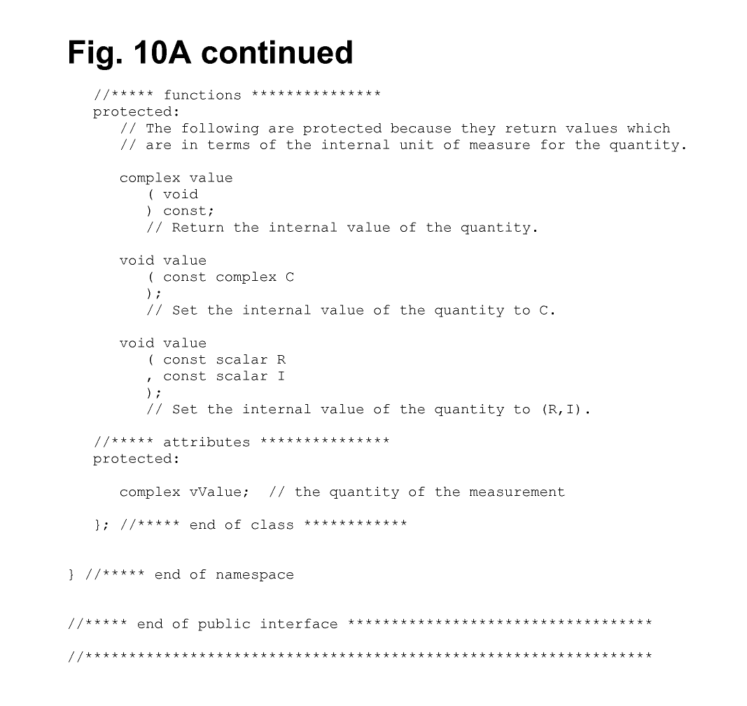

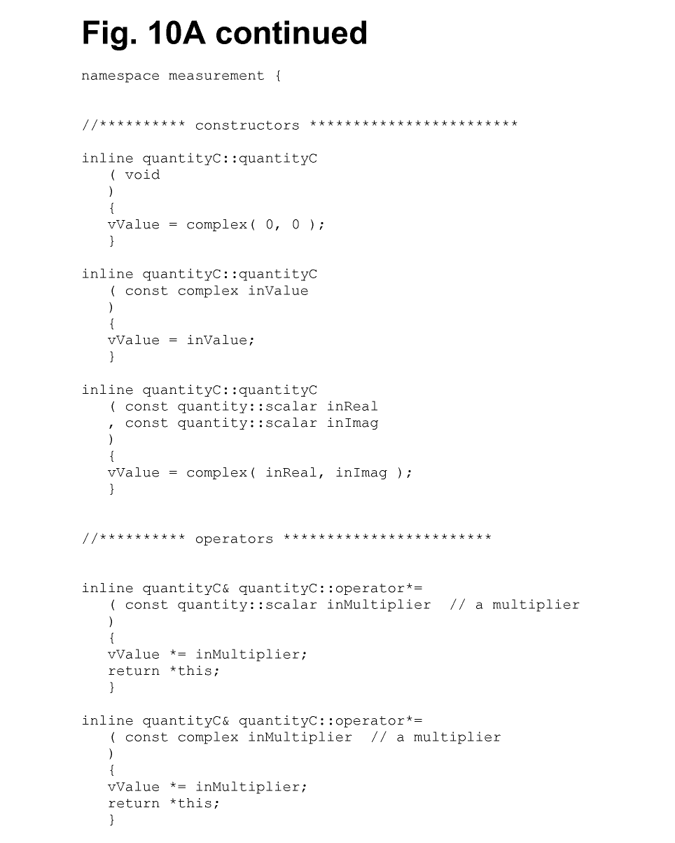

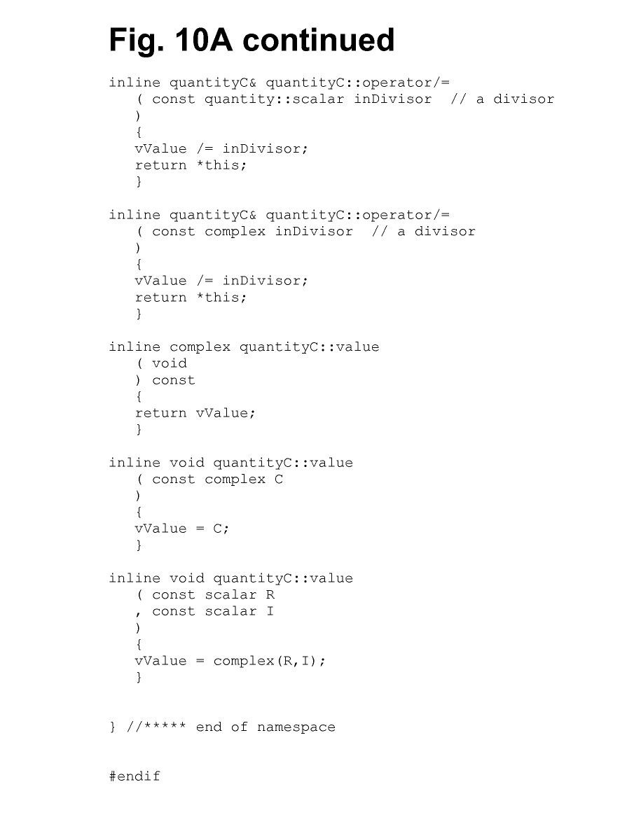

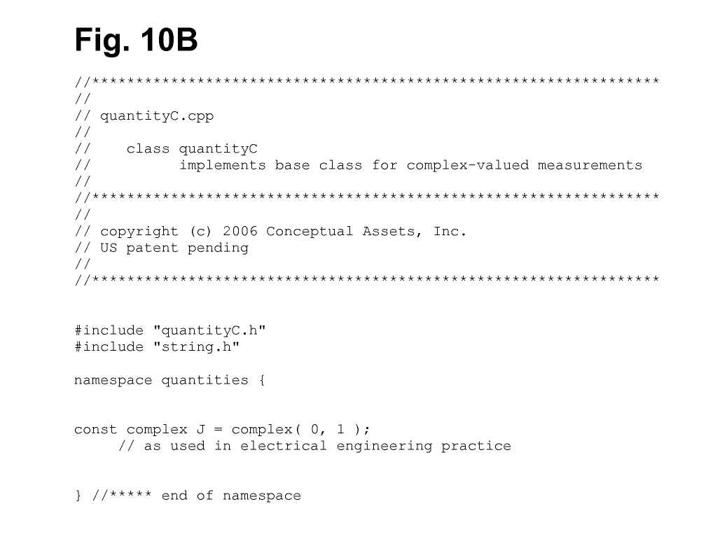

FIGS. 10A and 10B list C++ source code for an embodiment of a base class, ‘quantityC’, for complex-valued quantities. Base class ‘quantityC’, which is built in turn on base class ‘quantity’, is similar to the scalar-valued base class ‘quantityS’, except for additions needed to support complex values and arithmetic. Class ‘quantityC’ is slightly more complex because two values, namely the real and imaginary components, must be computed. The computation is simplified by employing the template class ‘complex’ from the C++ Standard Template Library (STL). The template class ‘complex’ provides ready-made definitions for complex arithmetic in each of several precisions. For each of the real and imaginary components, the embodiment of FIG. 10A uses the same ‘scalar’ numeric type and precision as used in the embodiment of FIG. 4A. A reason to use the same numeric type is that it is very reasonable that quantities of the property ‘voltage’ have the same type and precision as the real parts of quantities of the property ‘voltageAC’. Note that a quantity object of a complex-valued property class does not occupy any more memory space at run-time than would an ordinary complex number on the computer.

If the STL is unavailable for a specific compiler or if its equivalent is not available in a computer language, equivalent code may be derived from the STL template for the complex class by manual textual substitution to yield source code for complex arithmetic operators and other functions.

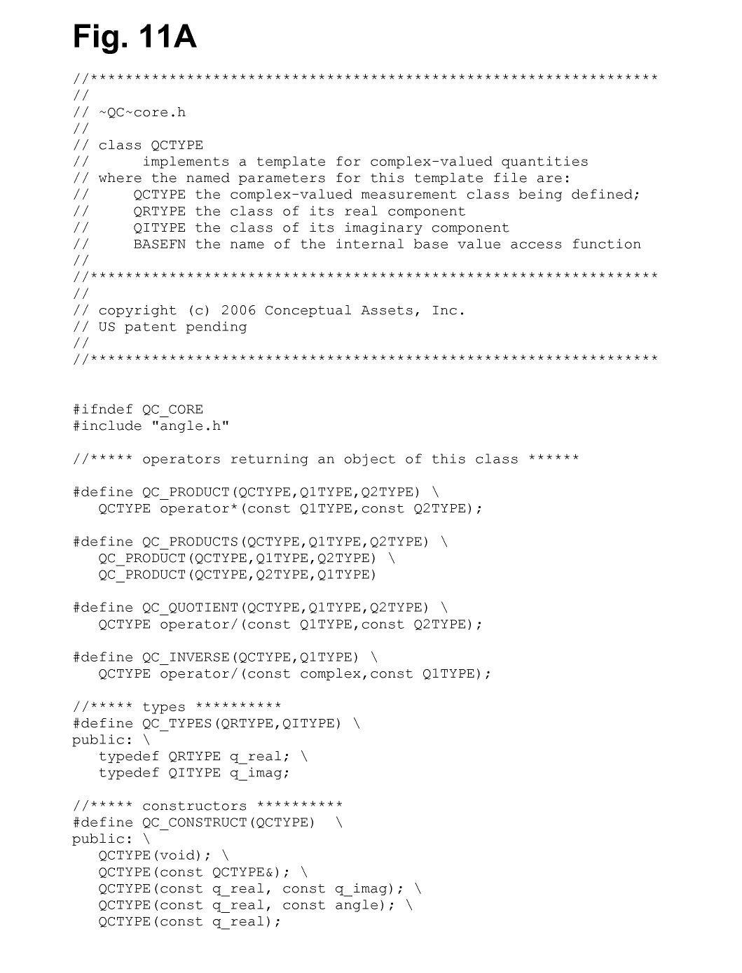

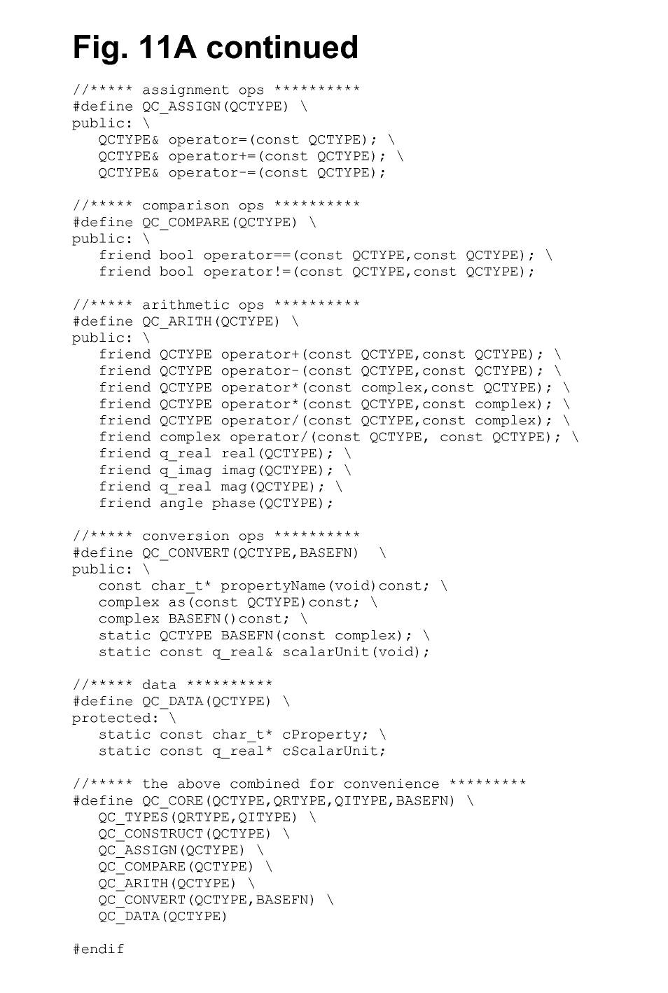

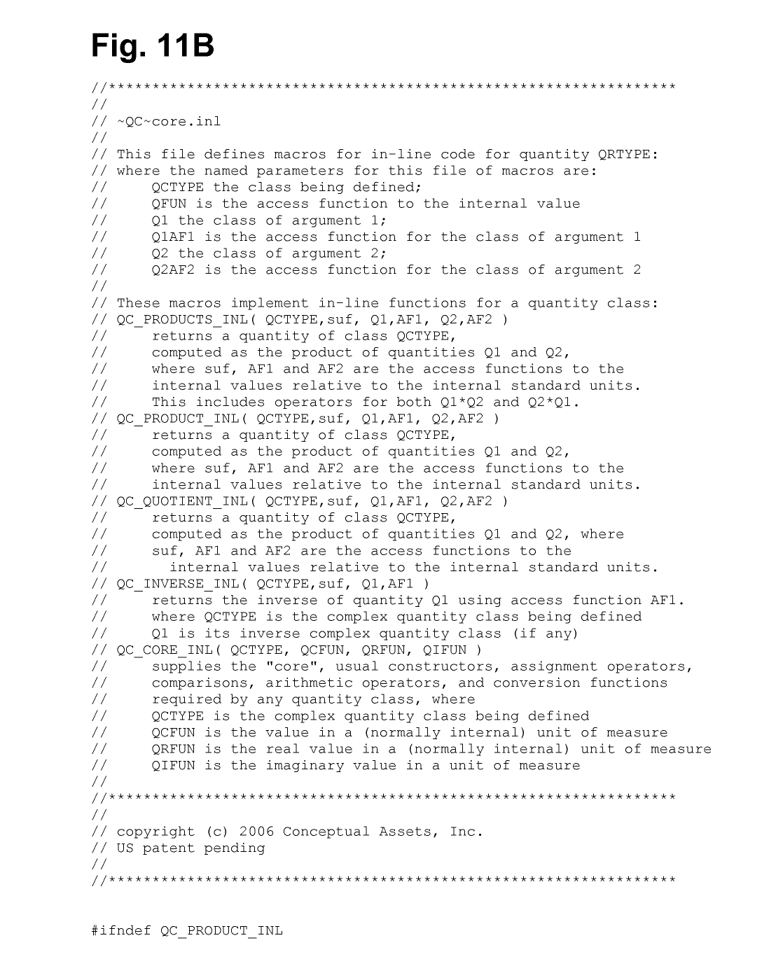

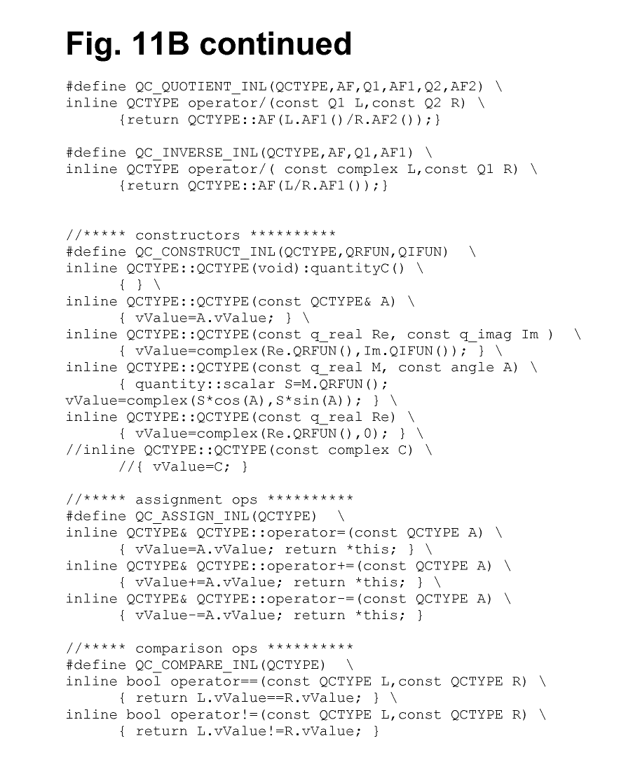

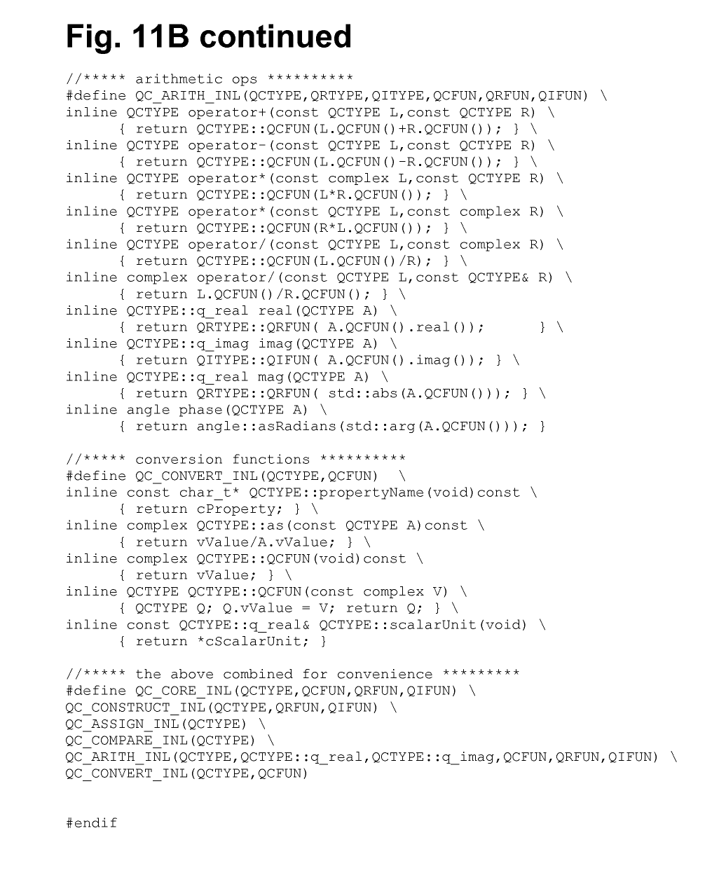

FIGS. 11A and 11B list an embodiment of macros which aid in the definition of a class for any new complex-valued quantitative property. Except for slight name changes and details related to using complex numbers instead of scalars, the macros are very similar to the macros in the embodiment of FIGS. 7A and 7B.

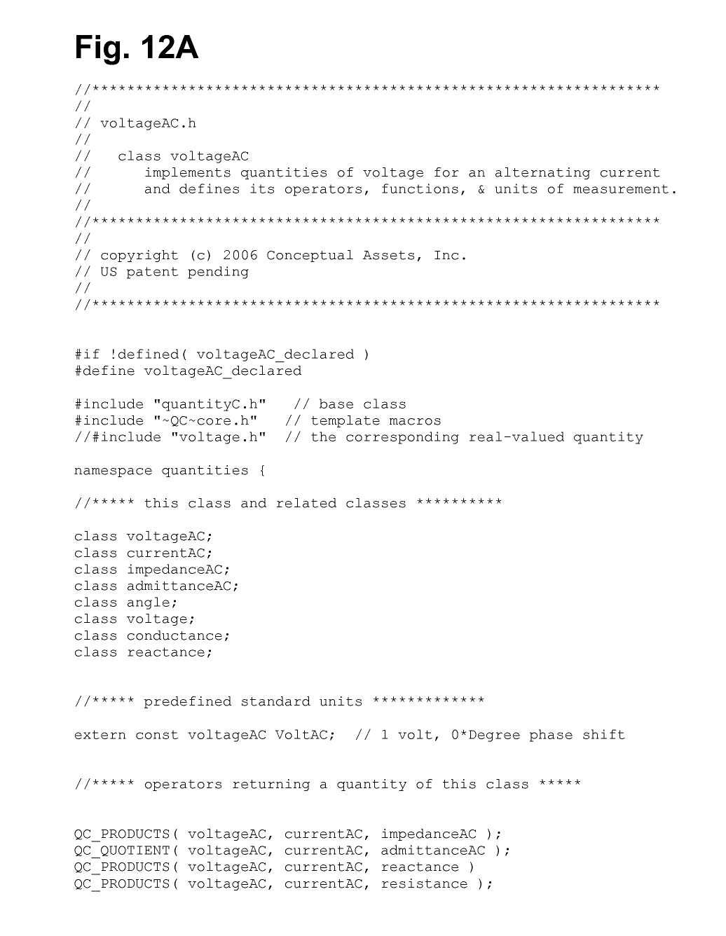

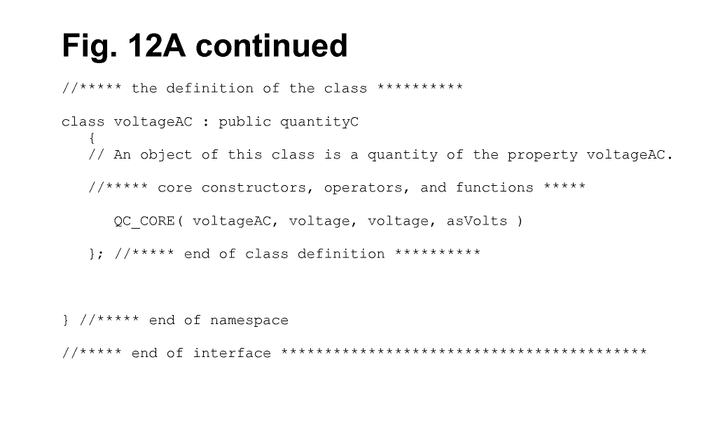

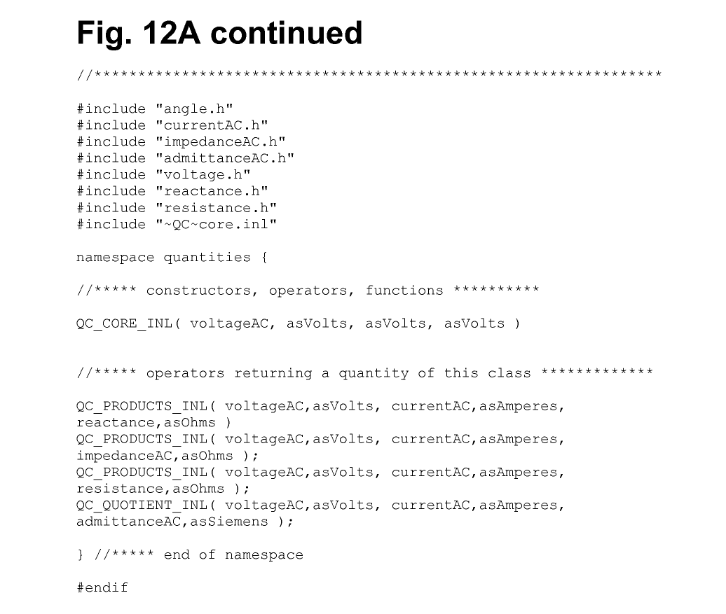

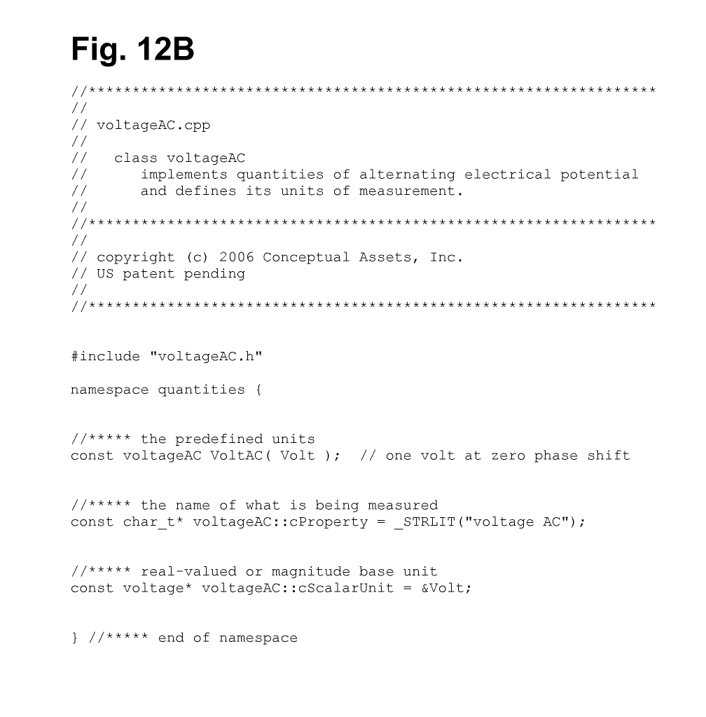

FIGS. 12A and 12B list source code for a C++ embodiment for a class representing quantities of sinusoidal AC (alternating current) voltage. The source code includes calls of the macros of FIGS. 11A and 11B to generate the operators and functions for object construction, assignment, comparison, and conversion of quantities from the property class ‘voltageAC’. The source code also includes macro calls to define complex-valued operator such as,

QC_PRODUCTS(voltageAC, currentAC, impedanceAC);

which declares a commutative multiplication operator representing Ohm's Law for alternating current. As before, only operator-operand combinations which have matching definitions (such as in an include file) will be validated as acceptable expressions when a compiler compiles the source code containing them.

Definition of classes for representing quantities of AC current (class currentAC), impedance (class impedanceAC), and admittance (class admittanceAC) can be very similar using macros such as those of the embodiments of FIGS. 11A and 11B. The differences for each class would include the declaration and definition of different units of measurement. Other differences would be the specific operators or functions which compute quantities of each class from operands or arguments of one or more of the other classes.

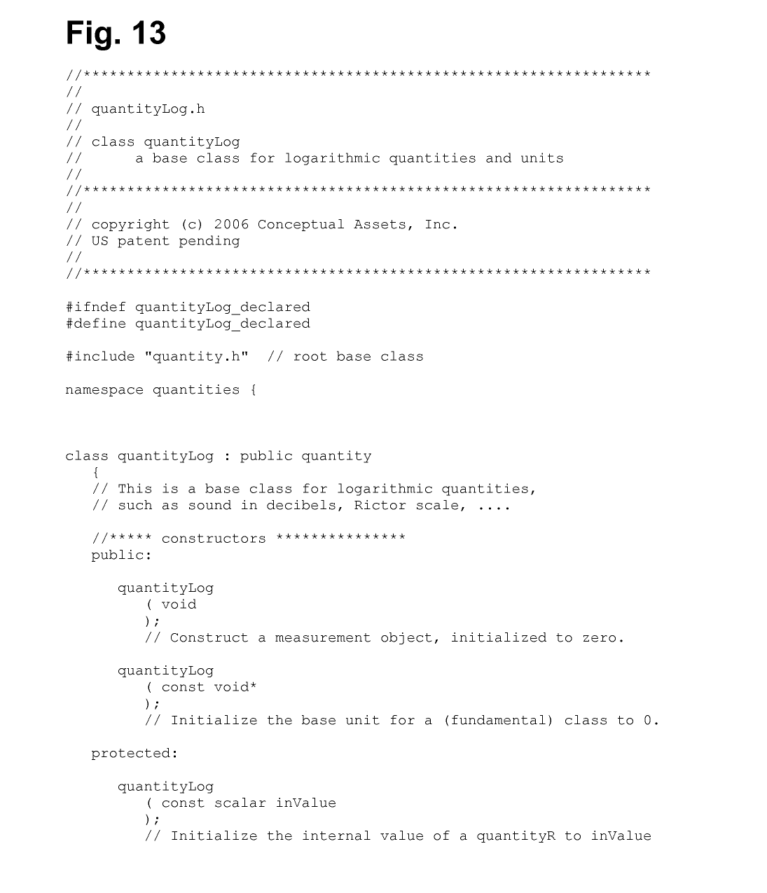

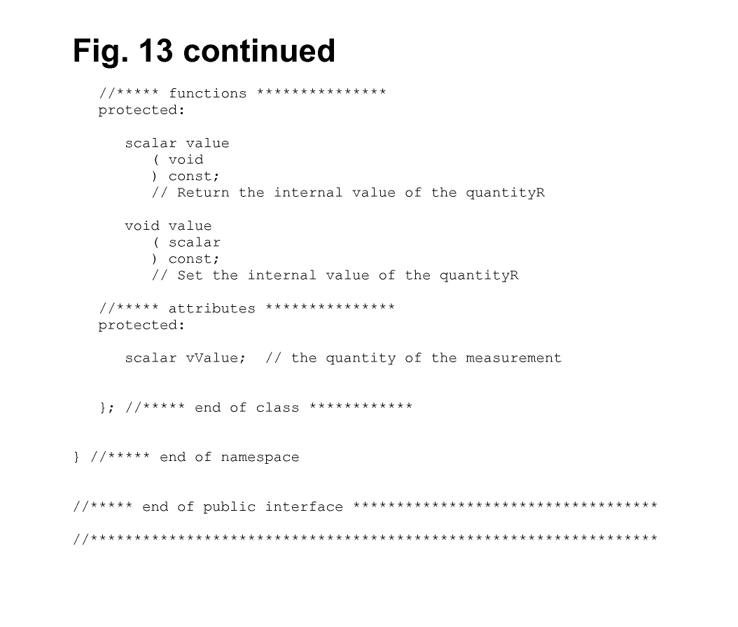

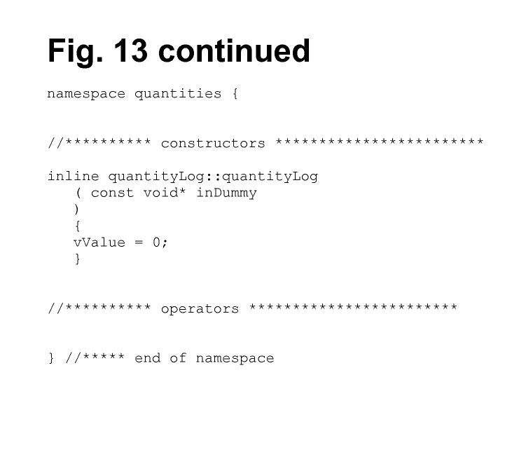

FIG. 13 is a source code listing for an embodiment for a base class (quantityL) definition for deriving a specific logarithmic-scale class. It is in a form similar to the base classes ‘quantityS’ and ‘quantityC’. Note that the operations for a logarithmic-scale class will be somewhat more restrictive. Note also that addition of logarithmic-scale quantities is equivalent to multiplying the implicit underlying linear-scale quantities.

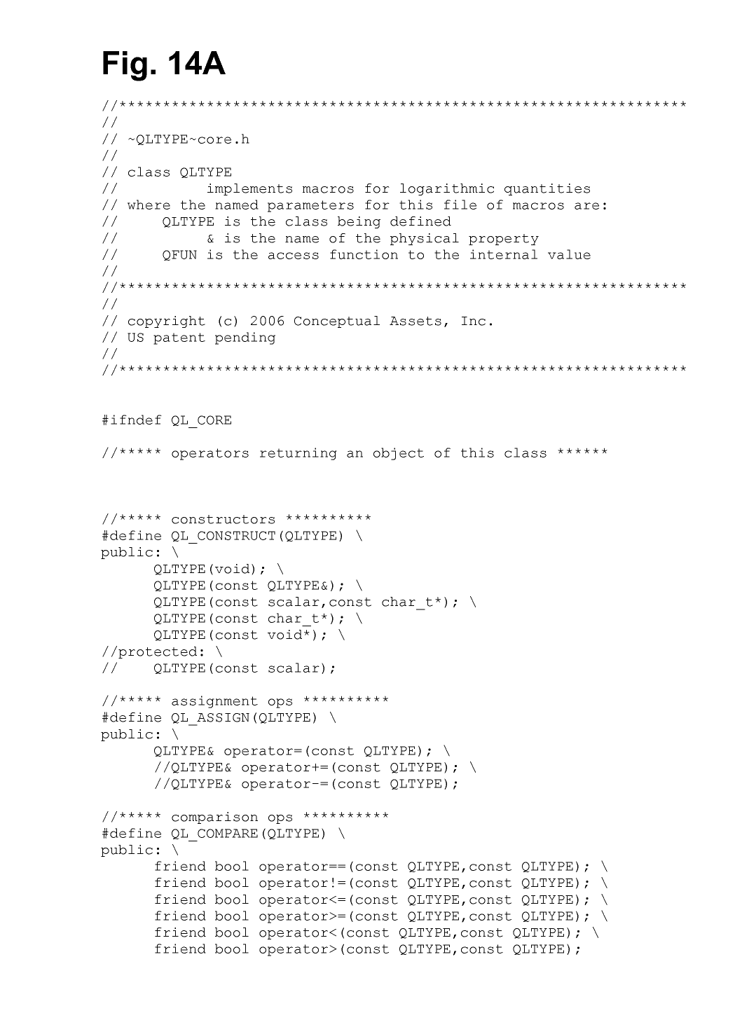

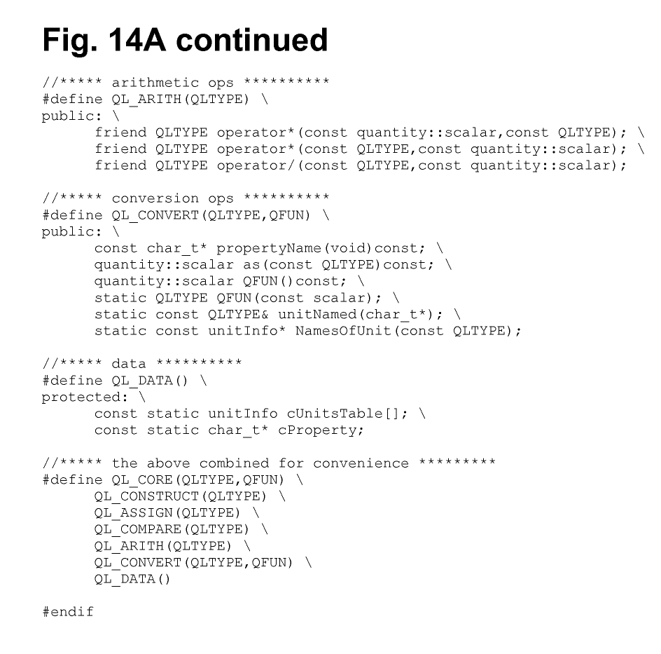

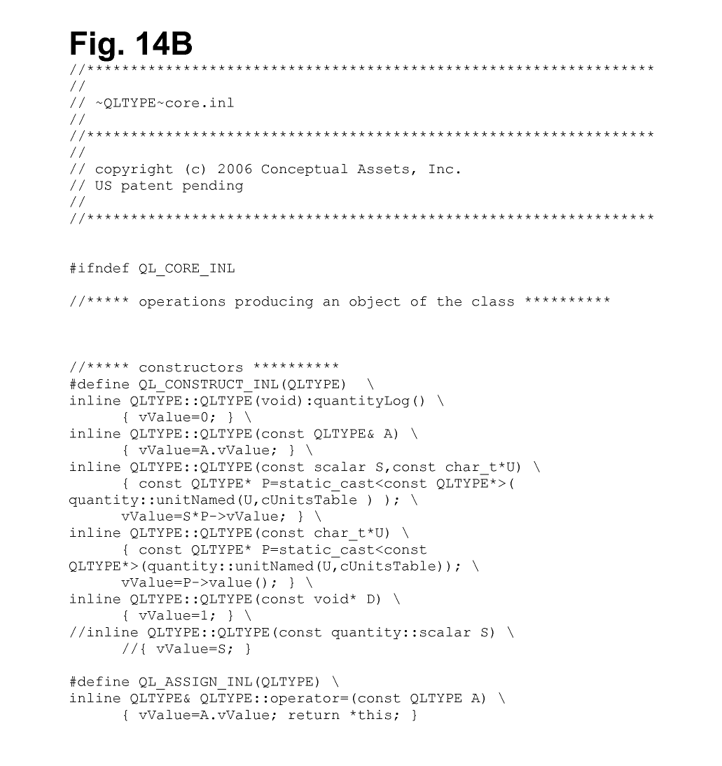

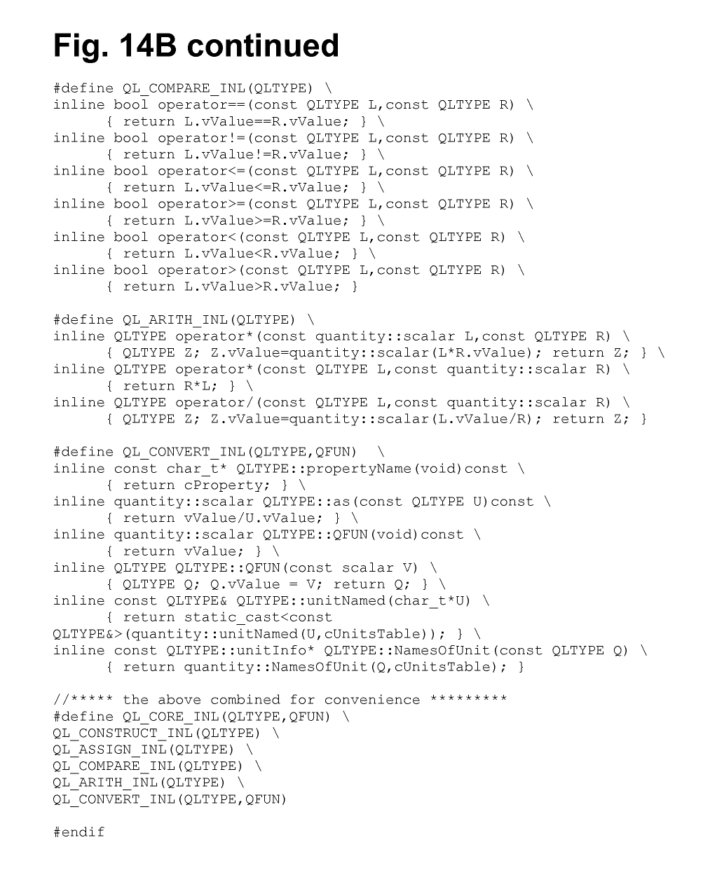

FIGS. 14A and 14B are source code listings for C++ macros for defining a logarithmic-valued class for a new logarithmic-scale quantitative property. The sets of macros ‘˜qL˜core.h’ and ‘˜qL˜core.inl’ are similar in form to the macros ‘˜qR˜core.h’, ‘˜qR˜core.inl’, ‘˜qC˜core.h’, and ‘˜qC˜core.inl’.

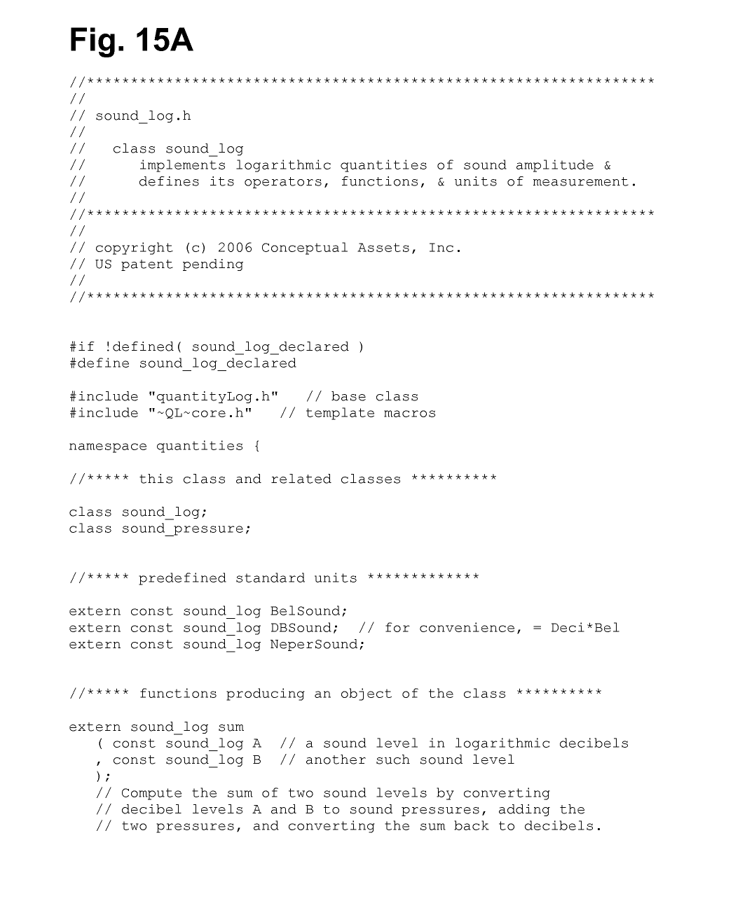

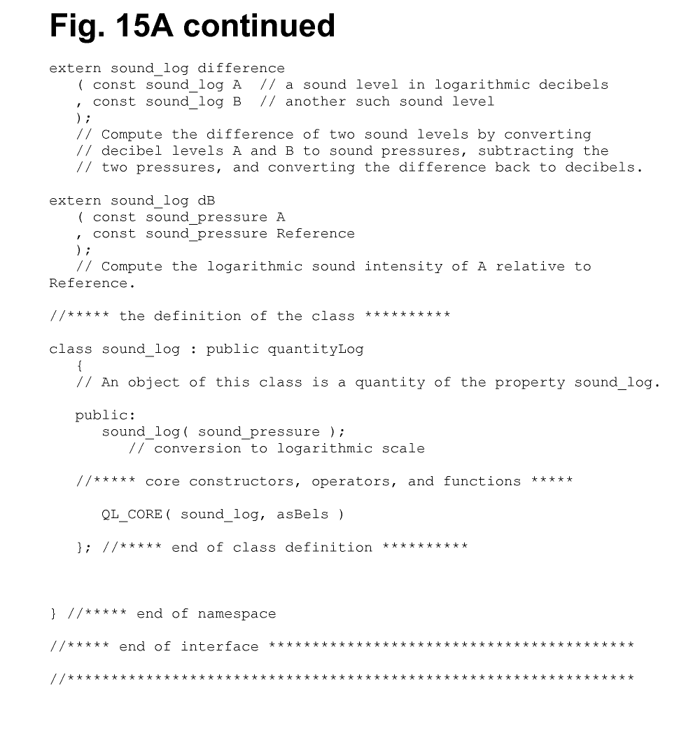

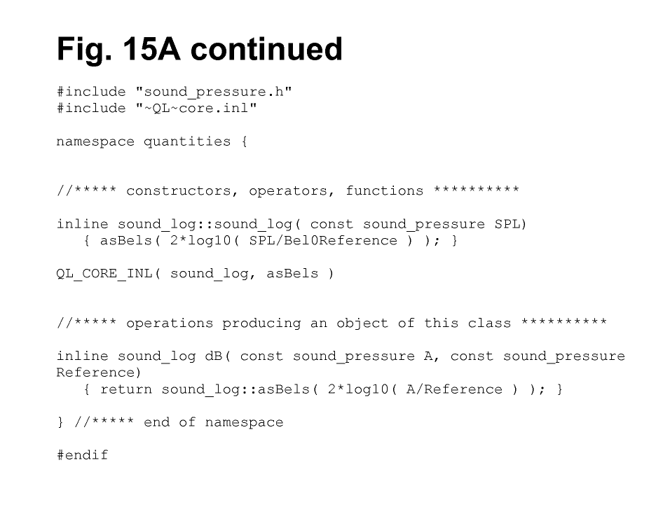

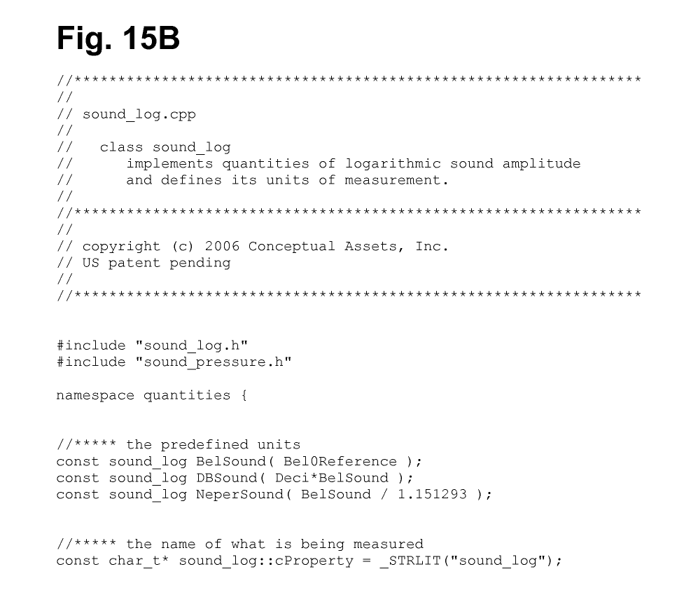

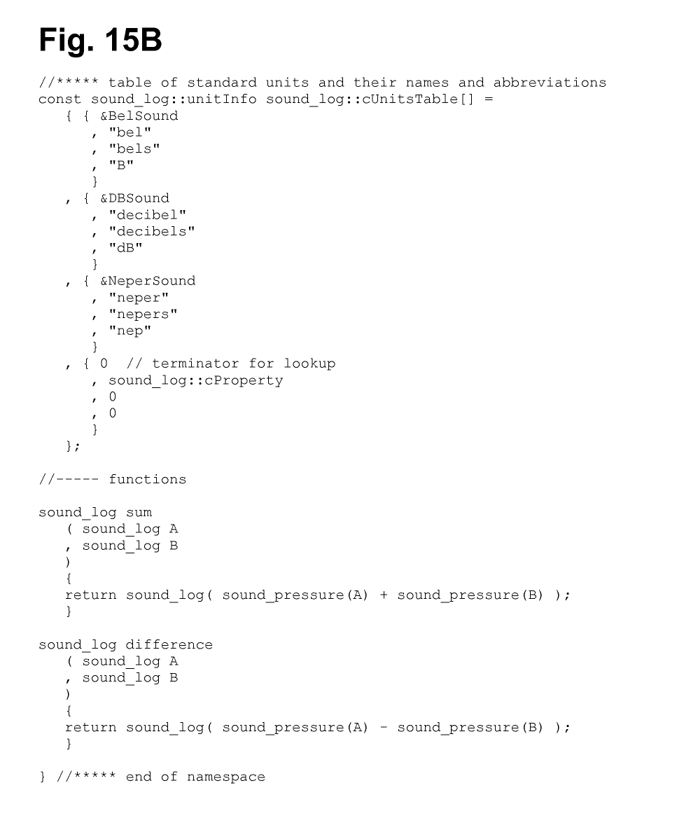

FIGS. 15A and 15B list a C++ embodiment for a logarithmic-scale class ‘sound_log’ representing the quantitative property sound intensity. Similar to the classes for velocity and AC voltage, the class ‘sound_log’ is generated by invoking macros from ‘˜qL˜core.h’ and ‘˜qL˜core.inl’ and using the base class ‘quantityLog’. Notice that logarithmic scales need a non-zero unit linear scalar reference for which the logarithm is zero. The property ‘sound_pressure’ is a linear-scale quantitative property. Its unit of measurement approximates the quietest sound that a human ear can hear. The logarithmic unit Bel is so defined that 0*Bel is the logarithmic measure of that scalar sound pressure.

Examples of other logarithmic scale quantitative properties include the seismic Richter scale, power amplification, radar reflectivity, and the musical scale of pitches. Classes to represent these properties can be built using the ‘˜qL˜core.h’ and ‘˜qL˜core.inl’ macros and the quantityL base class, similar to how ‘sound_pressure’ and ‘sound_log’ were defined. Predefined units for the musical scale would include the Octave and the HalfStep, for example, as well as a full octave of 11 notes such as the octave including “middle C” (constant objects PitchAFlat, PitchA, . . . PitchG). The underlying linear scale for musical pitch is frequency, and the linear reference can be the frequency (220 hertz) of the note ‘A’ below ‘middle C’. The linear reference is the value for which the corresponding logarithmic scale is zero. A C++ source code statement such as the following would make sense and be validated as valid source code by a compiler:

const music_pitch Sharp = HalfStep;
music_pitch SomeNote = PitchC+Sharp+2*Octave;
// a logarithmic representation of C# two octaves above middle C.

The embodiments herein have been illustrated exclusively in the C++ programming language. Nevertheless, the methods herein may be captured in parallel embodiments expressed in other programming languages albeit with changes in syntax at the least. The object code compiled from such source code, for example as an object code library, and run on a computer may form a programming system which implements the methods and which may originate as source code of a specific programming language. That is, some form of object code, such as a static or dynamically linked library, or interpreted pseudo-code, originating from source code employing the methods herein may be executed on a computer. Such object code executing on a computer constitutes a system for computing quantities using other quantities, in which the correct usage of the properties (dimensions) implicit in those quantities has been validated before execution.

A programming language with facilities for user-defined object-oriented classes or abstract data types can implement the methods and system described herein. Further, a language which allows overloading of the multiplication and division operators (* and /) is particularly well suited for implementing the method. However, a language such as standard C or Pascal, which allows user-defined data types, may be used to partially capture at least some of the ideas herein in an embodiment.

While the present invention has been disclosed with reference to specific example embodiments, numerous modifications, alterations, and changes to the described embodiments are possible without departing from the sphere and scope of the present invention, as defined in the appended claims. Accordingly, it is intended that the present invention not be limited to the described embodiments, but that it have the full scope defined by the language of the following claims, and equivalents thereof.

I claim:

1. A computer executable method to validate at compile time dimensional integrity of a mathematical expression expressed in a programming language, comprising:
compiling a class definition of each class of a plurality of classes, wherein each class of the plurality of classes uniquely represents one quantitative dimension of a plurality of quantitative dimensions;
compiling an object definition of each object of a plurality of objects, wherein each object of the plurality of objects belongs to one of the plurality of classes and represents a quantity of the quantitative dimension represented by the class to which the object belongs, and wherein at least one object of the plurality of objects represents a quantity which is a unit of measurement of the quantitative dimension represented by the class to which the at least one object belongs;
compiling a plurality of operator definitions, wherein:
each operator definition of the plurality of operator definitions corresponds to an operator symbol and one or more classes of the plurality of classes, and
the operator symbol represents a valid arithmetic relationship between two quantities of one or more quantitative dimensions of the plurality of quantitative dimensions and the one or more classes represent the one or more quantitative dimensions;
compiling the mathematical expression;
validating dimensional integrity of the mathematical expression by determining whether operator definitions exist in the plurality of operator definitions for each operator occurring in the mathematical expression; and
generating an error indication if there is no operator definition in the plurality of operator definitions for at least one operator occurring in the mathematical expression and if there is no other definition for the one operator in the programming language.

2. The method of claim 1, further comprising deriving the class definitions of at least two classes of the plurality of classes from a common base class.

3. The method of claim 1, further comprising invoking a parameterized macro which expands into source code which at least partially forms the class definition of at least one class of the plurality of classes.

4. The method of claim 1, further comprising invoking a parameterized macro which expands into source code which is one operator definition of the plurality of operator definitions.

5. The method of claim 1, wherein the unit of measurement is defined by the SI standard.

6. The method of claim 1, wherein:
a first class of the plurality of classes represents distance, and a first set of three objects of the plurality of objects belong to the first class and respectively represent the units of meter, foot, and inch; and
a second class of the plurality of classes represents period of time, and a second set of three objects of the plurality of objects belong to the second class and respectively represent the units of second, minute, and hour.

7. The method of claim 1, wherein one class of the plurality of classes represents a quantitative dimension having a linear scale.

8. The method of claim 1, wherein one class of the plurality of classes represents a quantitative dimension having a logarithmic scale.

9. The method of claim 1, wherein one class of the plurality of classes represents a quantitative dimension having complex values.

10. The method of claim 1, wherein the plurality of classes includes classes representing at least five of the following quantitative dimensions:
length, area, volume, time period, linear velocity, acceleration, flow,
angle, angular velocity, angular acceleration, solid angle,
activity, frequency, data amount, data rate,
energy, power, torque, force, mass, density, pressure,
moment, momentum, viscosity,
temperature, thermal expansion, thermal conductivity,
charge, charge density, electric field,
magnetic field, magnetic flux, magnetic flux density,
magnomotive force, magnetic moment,
substance, concentration, specific volume,
lens strength, refraction, sound pressure, sound intensity,
illuminance, luminance, luminosity, luminous energy, luminous flux,
voltage, current, resistance, resistivity, conductance, conductivity,
AC current, AC voltage, admittance, impedance, reactance, reluctance,
susceptance, capacitance, inductance, elastance, permeability, permittivity,
sound intensity, seismic energy, and power amplification.

11. The method of claim 1, further comprising adding a new class to the plurality of classes, wherein the new class represents a quantitative dimension not previously represented by any class in the plurality of classes.

12. The method of claim 1, wherein compiling the plurality of operator definitions includes compiling definitions for the following operators: addition, subtraction, multiplication, division, equals, not equals, less than, greater than, less than or equal, and greater than or equal.

13. The method of claim 1, wherein compiling an object definition of each object of a plurality of objects compiles an object definition of a constant object.

14. The method of claim 1, wherein compiling an object definition of each object of a plurality of objects compiles an object definition of a variable object.

15. A system for validating dimensional integrity of a mathematical expression in a programming language at compile time, comprising:
a computer including
an instruction processor, and
a memory having stored therein
source code statements of the programming language accessible to the instruction processor, and
a programming language compiler with instructions that cause the instruction processor to compile the source code statements,
wherein:
the source code statements define a plurality of classes, wherein each class of the plurality of classes uniquely represents one quantitative dimension of a plurality of quantitative dimensions;
the source code statements define a plurality of objects, wherein each object of the plurality of objects belongs to one of the plurality of classes, and the object represents a quantity of the quantitative dimension which the class to which the object belongs represents;
at least one object of the plurality of objects represents a quantity which is a unit of measurement of the quantitative dimension which the class to which the object belongs represents;
the source code statements include an definition for each operator of a plurality of operators, wherein:
the definition of each operator of the plurality of operator definitions corresponds to a unique combination of an operator symbol and one or more classes of the plurality of classes, and
the operator symbol represents a valid arithmetic relationship between two quantities of one or more quantitative dimensions of the plurality of quantitative dimensions and the one or more classes represent the one or more quantitative dimensions,
the source code statements contain the mathematical expression containing at least one operator;
the programming language compiler causes the instruction processor to validate the dimensional integrity of the at least one operator contained in the mathematical expression by determining whether the operator definition for the least one operator contained in the mathematical expression exists in the plurality of operator definitions; and
the programming language compiler causes the instruction processor to generate an error indication if there is no operator definition in the plurality of operator definitions for the at least one operator and if the compiler has no other definition for the one operator.

16. The system of claim 15, wherein the source code statements define at least two classes of the plurality of classes in terms of a common base class.

17. The system of claim 15, wherein the source code statements additionally contain a call to a parameterized macro which expands into source code which at least partially defines one class of the plurality of classes.

18. The system of claim 15, wherein the unit of measurement in the SI standard.

19. The system of claim 15, wherein the source code statements contain a definition of a parameterized macro and a call to the parameterized macro together with a set of actual parameters, wherein the call to the parameterized macro together with the set of actual parameters defines some or all of at least one class in the plurality of classes.

20. The system of claim 15, wherein the instruction processor generates object code which allocates the same amount of memory for one object of the plurality of objects as the instruction processor allocates for storing a floating point number having the same numerical range and precision as the range and precision of the one object.
